(19) United States
(12) Patent Application Publication
(10) Pub. No.: US 2026/0318238 A1
(43) Pub. Date: Oct. 15, 2026

(54) SYSTEMS AND METHODS FOR USING AMMONIA FUEL IN LINEAR GENERATORS

(71) Applicant: Mainspring Energy, Inc., Menlo Park, CA (US)

(72) Inventors: Wen Yu Peng, San Jose, CA (US); Matthew Svrcek, Redwood City, CA (US)

(21) Appl. No.: 19/485,197

(22) PCT Filed: May 28, 2024
(86) PCT No.: PCT/US2024/031315

§ 371 Date: Nov. 17, 2025

Related U.S. Application Data
(60) Provisional application No. 63/469,170, filed on May 26, 2023.

(51) Int. Cl. F01N 3/20; F02B 43/12; F02B 63/04; F02M 21/02

(52) U.S. Cl. CPC F01N 3/208; F01N 3/2066; F02B 43/12; F02B 63/041; F02M 21/0206; F01N 2610/02

(57) ABSTRACT

Systems and methods are presented herein for operating a linear generator to control content of exhaust produced by the linear generator based on reaction ammonia. The linear generator includes a reaction section arranged between a pair of opposed translators and an intake valve is to provide ammonia from a reservoir to the reaction section. The ammonia is mixed with compressed air from an air blower. An exhaust treatment assembly catalyzes exhaust products from the reaction section. At least one sensor monitors an output of the exhaust treatment assembly and a dosing valve, arranged between the at least one exhaust port and the exhaust treatment assembly, is actuated based on a signal from the at least one sensor. Control circuitry causes one or more of the intake valve or the dosing valve to distribute a modified amount of ammonia in order to change content of the exhaust products.

### CROSS-REFERENCE TO RELATED APPLICATIONS

This application claims the benefit of U.S. Provisional Patent Application No. 63/469,170 filed May 26, 2023, the disclosure of which is hereby incorporated by reference herein in its entirety.

### FIELD OF THE DISCLOSURE

The present disclosure is directed to generator systems and, more particularly, to systems and methods for providing ammonia fuel to linear generators.

### BACKGROUND

Generators that rely on ammonia-based fuel (e.g., mixed with air or oxygen), produce exhaust products that include nitrogen oxides (hereinafter “NOx”), nitrous oxide (hereinafter “N2O”), nitrogen, water, oxygen, and unreacted ammonia. Preferably, the reaction of ammonia fuel with air results in as little NOx in the produced exhaust as possible.

### SUMMARY

The present disclosure provides a linear generator that uses ammonia fuel and air, or any other suitable fuel, without generating NOx emissions that exceed target levels.

In some embodiments, the linear generator includes a reaction section arranged between a pair of opposed translators. At least one inlet port provides air and ammonia to the reaction section. An intake valve is in fluid communication with an ammonia reservoir, and provides ammonia from the reservoir to the at least one inlet port. An air blower is also in fluid communication with the at least one inlet port. The linear generator also includes an exhaust treatment assembly that catalyzes exhaust products from the reaction section. At least one exhaust port expels exhaust from the reaction section and is in fluid communication with the exhaust treatment assembly. A dosing valve of the linear generator is arranged between the at least one exhaust port and the exhaust treatment assembly. At least one sensor monitors an output of the exhaust treatment assembly. Control circuitry of the linear generator is configured to determine a target power output of the linear generator using one or more methods of this disclosure. The control circuitry also causes the intake valve to be adjusted to affect a volume of flow of ammonia from the ammonia reservoir to the at least one inlet port based on the target power output and causes the air blower to provide air that mixes with the flow of ammonia resulting in an air-fuel mixture propagating towards the at least one inlet port. As exhaust propagates past the at least one sensor, the control circuitry receives at least one signal from the at least one sensor and causes the exhaust dosing valve to be adjusted based on the at least one signal.

In some embodiments, the linear generator of the present disclosure is configured to operate on a fuel including ammonia (e.g., 100% anhydrous ammonia), while achieving the same or higher power output and efficiency as operation on other fuels such as natural gas, and while maintaining near-zero emissions of nitrogen-containing species including species of NOx, ammonia (also referred to herein as “NH3”), and nitrous oxide (also referred to herein as “N2O”). In some embodiments, for example, the emissions of NOx are held to less than 10 parts per million, NH3 less than 5 parts per million, and N2O less than 20 parts per million by volume of the exhaust stream, when operating based on the reaction of 100% anhydrous ammonia fuel. In some embodiments, the systems and methods of this disclosure are capable of causing the linear generator systems of this disclosure to meet target emission content levels at all target power outputs (e.g., ranging from 0% power output to 100% power output). A benefit of the systems and methods of this disclosure is that the use of ammonia (e.g., to react with air for power output generation) in any or all of the systems of this disclosure configured to operate according to any or all of the methods of this disclosure can be controlled in order to regulate the constituents of exhaust product when any or all of the systems of this disclosure are caused to generate anywhere from 0% of the maximum power output to 100% of the maximum power output. The system may include, for example, a fuel system, an air system, and an exhaust system integrated with a linear generator.

In some embodiments, the exhaust treatment assembly comprises at least one catalyst. Additionally, or alternatively, the at least one catalyst comprises one or more of a selective catalytic reduction catalyst or an ammonia slip catalyst.

In some embodiments, the target power output is determined based on a current operating state and a look-up table. Additionally, or alternatively, the target power output is determined based on one or more of a current cycle of the linear generator or a preceding cycle of the linear generator. In some embodiments, the target power output can be determined based on a power meter (e.g., as defined by a campus with multiple structures or devices that draw power from one or more linear generator systems of this disclosure). For example, a grid-tie inverter for a particular device or campus can be configured to define one or more of a grid frequency or a voltage to be generated based on operation of the one or more linear generator systems of the present disclosure.

In some embodiments, the linear generator is to cause a reaction to occur in the reaction section by compressing the air-fuel mixture using the pair of opposed translators.

In some embodiments, the intake valve comprises an opening. The intake valve is configured to be adjusted by changing the size of the opening. Additionally, or alternatively, the control circuitry is further configured to adjust the size of the opening based on the target power output.

In some embodiments, the at least one signal from the at least one sensor comprises data indicative of exhaust content.

In some embodiments, the control circuitry is further configured to cause the air blower to provide an amount of the air to generate a target air-fuel ratio in the air-fuel mixture based on the target power output. Additionally, or alternatively, the control circuitry is further configured to determine the linear generator is in a startup condition. In response to determining the linear generator is in the startup condition, determining the target power output comprises determining the target power output based on predictive operational parameters.

In some embodiments, the control circuitry is further configured to determine the linear generator is no longer in the startup condition. The control circuitry is also configured to determine an updated target power output based on a previous cycle of the linear generator and based on the at least one signal from the at least one sensor, and adjust the intake valve based on the updated target power output. Additionally, or alternatively, the control circuitry repeats the determination of the updated target power output and the adjusting of the intake valve until the at least one signal of the at least one sensor indicate that a criterion for exhaust content has been met.

In some embodiments, the present disclosure is directed to a method of operating a linear generator, the linear generator comprising at least one inlet port to provide air and ammonia to a reaction section arranged between a pair of translators, an intake valve to provide ammonia from a reservoir to the at least one inlet port, an air blower in fluid communication with the at least one inlet port, at least one exhaust port to expel exhaust from the reaction section, the at least one exhaust port in fluid communication with an exhaust treatment assembly that catalyzes exhaust products from the reaction section, a dosing valve arranged between the at least one exhaust port and the exhaust treatment assembly, and at least one sensor that monitors an output of the exhaust treatment assembly. The method includes using control circuitry for determining a target power output of the linear generator, causing the intake valve to be adjusted to affect a volume of flow of ammonia from the ammonia reservoir to the at least one inlet port based on the target power output, causing the air blower to provide air that mixes with the flow of ammonia resulting in an air-fuel mixture propagating towards the at least one inlet port, receiving at least one signal from the at least one sensor, and causing the exhaust dosing valve to be adjusted based on the at least one signal.

In some embodiments, determining the target power output comprises receiving a linear generator operational load setpoint, and computing the target power output based on the load setpoint.

In some embodiments, determining the target power output comprises identifying a current operating state of the linear generator, and selecting the target power output from a look-up table based on the current operating state.

In some embodiments, criterion of the exhaust content is based on respective levels of one or more of ammonia or nitrogen oxide in the exhaust content.

In some embodiments, the present disclosure is directed to a system for generating and storing energy for distribution. The system includes an electrolyzer to apply electric current to chemical compounds and an air separation chamber to separate constituents of the chemical compounds subjected to the electric current. At least one constituent storage tank is available for each separated constituent. A linear generator generates an electrical power output based on reaction of one or more of the separated constituents.

In some embodiments, the present disclosure is directed to a method of operating a linear generator based on a compression ratio. Using control circuitry of the linear generator, a target power output of the linear generator is determined along with a current compression ratio. The control circuitry causes ammonia from an ammonia reservoir to be provided to an inlet port of the linear generator based on the target power output. An air blower is caused (e.g., by the control circuitry) to provide air that mixes with the ammonia such that an air-fuel mixture propagates towards the inlet port. Translators of the linear generator compress the air-fuel mixture based on the current compression ratio (e.g., based on instructions from the control circuitry). The control circuitry receives at least one signal from at least one sensor, wherein the at least one sensor generates the at least one signal to characterize a criterion of exhaust content generated based on compression of the air-fuel mixture. The current compression ratio of the linear generator is adjusted, using the control circuitry, to an updated compression ratio based on the criterion, wherein the updated compression ratio modifies reaction parameters based on compression of the air-fuel mixture. Additionally, or alternatively, the control circuitry causes an ammonia dosing valve to be adjusted to provide ammonia to exhaust generated based on compression of the air-fuel mixture between the translators.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 is a block diagram of an example linear generator system that operates using a mixture of air and ammonia in accordance with some embodiments of the present disclosure;

FIG. 2 is a block diagram of an illustrative linear generator system having a control system and sensors in accordance with some embodiments of the present disclosure;

FIG. 3A is an illustrative plot characterizing how air flow affects concentration of exhaust products in accordance with some embodiments of the present disclosure;

FIG. 3B is an illustrative plot characterizing how an amount of air flow affects compression for an optimum reaction in accordance with some embodiments of this disclosure;

FIG. 4 is a flowchart of an illustrative process for controlling a linear generator operating on ammonia in accordance with some embodiments of the present disclosure;

FIG. 5 is a flowchart of an illustrative process for controlling distribution of ammonia in a linear generator in accordance with some embodiments of the disclosure;

FIG. 6 is a block diagram of an illustrative integrated linear generator system, in accordance with some embodiments of the present disclosure;

FIG. 7 shows a cross-sectional view of an illustrative two-piston, two-stroke linear generator with integrated gas springs in accordance with some embodiments of the present disclosure;

FIG. 8 shows an illustrative two-stroke piston cycle of the linear generator of FIG. 7 in accordance with some embodiments of the present disclosure;

FIG. 9 is a block diagram of an illustrative linear generator system in accordance with some embodiments of the present disclosure;

FIG. 10 shows a cross-sectional view of an illustrative gas spring system in accordance with some embodiments of the present disclosure;

FIG. 11 shows a block diagram of an illustrative phase control system in accordance with some embodiments of the present disclosure;

FIG. 12 shows a stacked set of two core linear generator assemblies in accordance with some embodiments of the present disclosure; and

FIG. 13 is a block diagram of an illustrative fueling architecture in accordance with some embodiments of the present disclosure.

### DETAILED DESCRIPTION

The present disclosure is directed to systems and methods for operating a linear generator to control content of exhaust from reactions of a fuel to cause the linear generator to generate electrical power output. As alternative fuels are identified for generating electrical energy, controlling the content of exhaust produced becomes important to ensuring these alternative fuels are beneficial to use in place of conventional fuels. For example, ammonia is a promising green fuel for carbon-free power generation. However, the presence of a nitrogen atom in the fuel molecule means some amount of NOx formation during reaction of ammonia with air is unavoidable. Even a low-temperature reaction such as that employed in a linear generator, which normally produces near zero NOx emissions on any non-nitrogen-containing fuel, will form some amount of NOx when using ammonia as the fuel. The present disclosure provides examples of regulating, or reducing, the presence of certain chemical compounds in exhaust products that are the results of reactions of fuel to operate a linear generator.

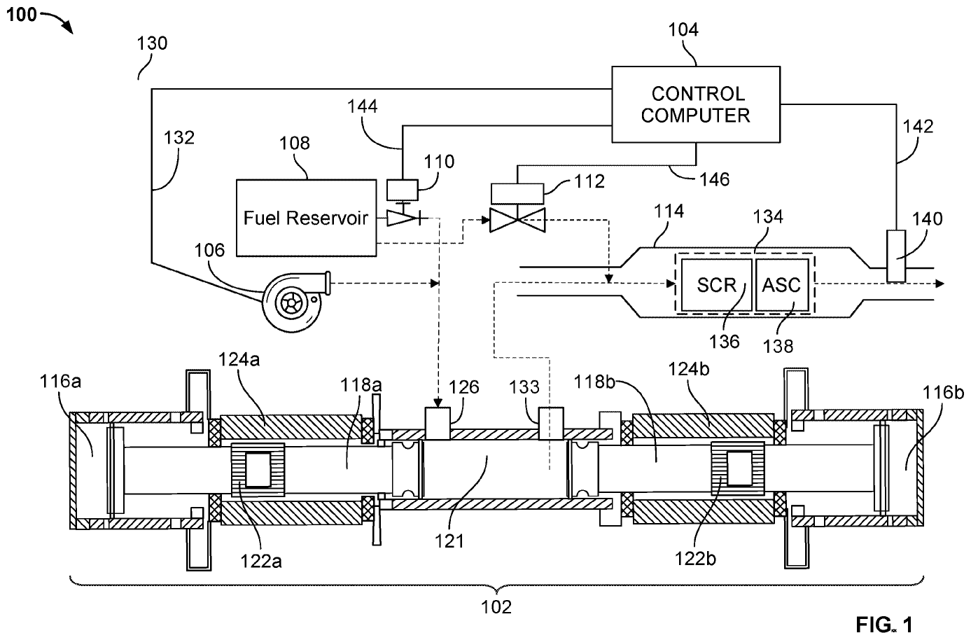

FIG. 1 shows linear generator system 100 which operates based on a reaction of an ammonia-air mixture to generate an electrical power output. Linear generator system 100 includes linear generator assembly 102, control computer 104, air blower 106, fuel reservoir 108, intake valve 110, dosing valve 112, and exhaust assembly 114. Control computer 104 includes any suitable arrangement of hardware (e.g., control circuitry that may include any suitable one or more processors and communicative interfaces for generating and transmitting commands based on data generated, computed, or received from sensors), software or both. Linear generator assembly 102 includes gas springs 116a and 116b for rebounding translators 118a and 118b, respectively, after a reaction occurs in reaction section 121.

A translator corresponds to an assembly that uses a piston rod to couple a piston (e.g., where the piston face is in contact with a reaction section) to an opposing component that provides a return force responsive to a reaction in the reaction section. A translator electromagnetically interacts with a stator with a plurality of windings to convert mechanical energy of the translator to an electrical output. Each translator as described herein comprises at least a translator tube that connects to opposing pistons. The translator tube comprises any suitable beam shape, or geometry for connecting the opposing pistons (e.g., such as a rod or cylinder). In some embodiments, each translator of the plurality of LEMs comprises a respective number of magnets. In some embodiments, each respective translator translates along the longitudinal axis within a respective cylinder. Linear generator system 100 can also include a respective bearing housing for supporting each respective translator. Each respective bearing housing accommodates a respective gas bearing. Each respective bearing housing comprises one or more of at least one port or at least one valve for modifying a pressure of a respective gas within each respective bearing housing. In some embodiments, the gas springs of linear generator system 100 provides pressurized gas to at least one of the respective bearing housings.

The reaction within reaction section 121 creates pressure that pushes translators 118a and 118b away from reaction section 121. Translators 118a and 118b include magnet portions 122a and 122b, respectively, which interface with stators 124a and 124b, respectively, to generate an electrical power output. Fuel reservoir 108 can be used to store pure ammonia, or ammonia with any suitable additives, for reacting with air in reaction section 121. In some embodiments, the fuel reservoir may be local to the linear generator such as part of the balance of plant (e.g., which can be abbreviated to “BoP”) and in other embodiments it may be remote, such as at a chemical plant. The ammonia may be fed to the linear generator via a pipeline that is fed by a reservoir or a real-time ammonia generation system. Intake valve 110 is actuated (e.g., based on instructions provided by control computer 104) to cause ammonia to be fed towards inlet port 126. Intake valve 110 comprises any suitable valve structure for regulating flow of ammonia out of fuel reservoir 108 (e.g., one or more of a stop valve, a plug valve, a ball valve, a butterfly valve, or a gate valve). In some embodiments, intake valve 110 is a solenoid valve that is actuated based on an instruction transmitted from control computer 104. Inlet port 126 can include one or more features (e.g., one or more of slots, openings, or actuated valves or doors) configured to enable the ingress of a mixture of fuel and air into reaction section 121.

It will be understood that linear generator system 100 is merely an illustrative architecture. The present disclosure is applicable to any other suitable architecture. For example, any suitable linear generator assembly may be used in place of or in addition to linear generator assembly 102. In some embodiments, a non-linear generator may be used in place of linear generator assembly 102. In some embodiments, a generator that includes mechanically linked pistons (e.g., using a crank shaft) may be used in place of free pistons. In some embodiments, any other fuel may be used in place of or in addition to ammonia. For example, the present disclosure contemplates fuels that include hydrogen, biodiesel, ethanol, natural gas, propane, renewable diesel, sustainable aviation fuel, any other suitable emerging fuel, methane, or any combination thereof. In some embodiments, fuel reservoir 108 may include one or more reservoirs that are integrated into linear generator system 100 (e.g., as a physical component of an integrated deployable system), is located proximate to linear generator system 100 (e.g., at a location in which linear generator system 100 is deployed), is remote to linear generator system 100 (e.g., and couple by way of, for example, piping or any other form conduit), or any combination thereof. In some embodiments, any other suitable gas, in place of or in addition to air, may be mixed with the fuel. For example, oxygen may be used in addition to or in place of air (e.g., using a pressurized source of oxygen that is in fluid communication with air blower 106). For purposes of brevity and clarity, and not by way of limitation, the present disclosure is provided in the context of the architecture and arrangement shown in FIG. 1. As discussed above, it will be understood that any suitable modifications are contemplated by the present disclosure.

As shown in FIG. 1, blower 106 receives instructions (e.g., an air flow command) from control computer 104 using communication channel 132 to provide ambient air from an environment external to linear generator system 100 to the fuel lines leading to inlet port 126 in order to assist with cultivating a target air-fuel mixture prior to reaction of the air-fuel mixture in reaction section 121. Additionally, or alternatively, a ventilation system includes an intercooler (not shown) that operates to lower a temperature of air after it has been boosted in pressure by the blower 106 of linear generator system 100.

The pressure of air supplied to the air-fuel mixture can be considered by control computer 104 in order to provide for an ideal reaction in reaction section 121. Control computer 104 also provides a boost air flow command over communication channel 132 to air blower 106 to provide a way to control the content of the air-fuel mixture (e.g., by achieving desired compression and by achieving desired ratios of air to fuel within the mixture). Within reaction section 121, translators 118a and 118b move towards each other to compress the air-fuel mixture received through inlet port 126. Compression causes the air molecules and fuel molecules to collide more energetically until they spontaneously disassemble and then reassemble into nitrogen and water molecules. The nitrogen and water molecules contain lower chemical energy, and higher kinetic energy, than the initial fuel and air molecules, resulting in an increase in pressure within the reaction section 121. This pressure also drives translators 118a and 118b, each of which comprise one or more magnets, outward towards gas springs 116a and 116b. Magnetic portions 122a and 122b cause electrical power to be generated as they pass stators 124a and 124b, respectively, based on the arrangement of coils (e.g., copper coils) that comprise each of stators 124a and 124b. As each of these translators reach an outward position (e.g., bottom dead center as at least partially defined by pressure within each of gas springs 116a and 116b), the reaction products (e.g., exhaust product) are pushed out through exhaust port 133 by the air-fuel mixture supplied through inlet port 126 for a subsequent reaction within reaction section 121 (e.g., by uniflow scavenging).

When the air-fuel mixture is based on the introduction of ammonia into compressed air, nitrogen and water are expected to be the predominant content of the exhaust produced from the compression based reaction within reaction section 121. Certain conditions of the reaction, however, can result in other exhaust products being formed such as various species of nitrogen oxides (e.g., species of NOx such as one or more of nitric oxide, or nitrogen dioxide). Moreover, the conditions of the reaction can lead to at least a portion of the ammonia of the air-fuel mixture remaining unreacted. Linear generator system 100 is configured to operate based on execution of one or more methods of this disclosure to minimize or eliminate one or more of these products of the reaction during various operative states of linear generator system 100. As shown in FIG. 1, one manner of addressing these exhaust products is by incorporating exhaust treatment assembly 134 within exhaust assembly 114 to provide one or more catalysts to treat the exhaust products as they propagate through exhaust assembly 114.

Exhaust treatment assembly 134 may include at least one catalyst. As shown in FIG. 1, the at least one catalyst may include selective catalytic reduction (hereinafter “SCR”) catalyst 136. SCR catalyst 136 facilitates the reaction of ammonia with nitric oxide, nitrogen dioxide, and excess oxygen in order to form nitrogen and water as an exhaust product. Globally, the dominant reactions can be described as follows (recognizing there are many reaction sub-steps):

NH₃+NO+1/4O₂→N₂+3/2H₂O

NO₂+2NH₃+1/2O₂→3/2N₂+3H₂O

NO+NO₂+2NH₃→2N₂+3H₂O

Complete reaction in the catalyst, and therefore minimal ammonia and NOx in an outlet of exhaust assembly 114, requires the correct ratio of ammonia to NOx be fed to the inlet of SCR catalyst 136. In practice, maximum conversion of NOx is achieved by providing a slight excess of ammonia to ensure at least one ammonia molecule is available at every surface site on SCR catalyst 136 where there is an expectation of a presence of at least one molecule of NOx. Any excess ammonia particles not stored in the catalyst can also be oxidized by a second catalyst, as shown in FIG. 1, which may include, for example an ammonia slip catalyst (hereinafter “ASC”) 138. ASC 138 can be installed in a same housing as SCR catalyst 136 (e.g., within exhaust treatment assembly 134). It will be understood that any suitable catalyst or any other exhaust treatment mechanism or technique may be used in addition to or in place of what is shown in FIG. 1.

Sensor 140 is installed towards an outlet of exhaust assembly 114 after exhaust treatment assembly 134. Sensor 140 may include any suitable number of sensors either of the same type or of different types. Sensor 140 collects data to characterize content of exhaust that was catalyzed and generates at least one signal (e.g., corresponding to exhaust content data signal 142) to control computer 104. Exhaust content data signal 142 communicates content of the exhaust based on the sensing capabilities of sensor 140. For example, sensor 140 can be configured to detect amounts of one or more of ammonia or various species of nitrogen oxide in the exhaust generated from the reaction within reaction section 121. In some embodiments, sensor 140 includes one or more oxygen sensors or other sensors for detecting particular exhaust product constituents (e.g., including electrochemical sensors).

Control computer 104 functions as a central control circuitry arrangement for processing exhaust content data signal 142 in order to provide operational instructions for intake valve 110, air blower 106, and dosing valve 112. Initially, control computer 104 is able to provide a power output command over communication channel 144 to intake valve 110 based on a target power output (e.g., based on an expected electrical output generated through coils of each of stators 124a and 124b). This target power output results in identification, for example, of an ideal air-fuel ratio in an air-fuel mixture to be provided to reaction section 121 for compression by translators 118a and 118b. In some embodiments, additional control algorithms can be run by control computer 104 in order to affect the apex achieved by either, or both, of translators 118a or 118b or to generally regulate the respective positioning of these assemblies (e.g., based on one or more of braking techniques or synchronization of the movement of translators 118a and 118b with respect to each other).

Control computer 104 generates the power output command for transmission using communication channel 144 based at least in part on the architecture of intake valve 110. For example, intake valve 110 can be configured to remain open and saturate fuel lines with ammonia such that blower 106 is provided the boost air flow command over communication channel 132 to achieve ideal compression based on a target air-fuel ratio in the air-fuel mixture to be reacted. Intake valve 110 can, therefore, be progressively or selectively closed (e.g., intake valve 110 comprises an opening and intake valve 110 is configured to be adjusted by changing a size of the opening based on the power output command provided using communication channel 144). Additionally, or alternatively, the boost air flow command is provided using communication channel 132 is processed by air blower 106 based on desired operation of linear generator system 100. For example, both the target power output for an upcoming operational cycle and the exhaust content data from a previous operational cycle can be used as variables in determining how much air blower 106 is expected to compress air (e.g., resulting in the target air-fuel mixture for reaction).

Control computer 104 is also configured to provide a fuel dosing command over communication channel 146 to dosing valve 112 in order to modify exhaust content in a subsequent cycle based at least in part on exhaust content data from a previous operational cycle or a range of previous operational cycles (e.g., as communicated by exhaust content data signal 142). A cycle as used in this disclosure corresponds to a translator of this disclosure actuating within a cylinder from a top-dead-center position to a bottom-dead-center position and back to a top-dead-center position. As the translator approaches the top-dead-center position, the cycle includes causing a reaction to occur between a pair of opposed translators (e.g., by compression ignition). In some embodiments, a previous cycle is any cycle that occurred before a current cycle. A subsequent cycle is considered any cycle that occurs after a current cycle. Exhaust sensing in this disclosure can occur as a continuous manner independent of being defined by a particular cycle and control of one or more of the air-fuel mixing, the reaction thereof, or the exhaust dosing can be achieved based on a continuous monitoring of the exhaust.

Depending on the conditions of a reaction in reaction section 121 for each respective cycle of operation of linear generator assembly 102 (e.g., one or more of respective translator positions within the cylinder, pressure within the reaction section, air-fuel ratios within the air-fuel mixture, or potential contaminants within the reaction section), a reduction in the amount of NOx, and related species of nitrogen oxide, can result in the generation of elevated levels of nitrous oxide as an exhaust product. In some embodiments, the levels of nitrous oxide are minimized during operation of linear generator system 100, or the levels of nitrous oxide are to be minimized through a series of operational cycles. In some embodiments, intake valve 110 is connected in series with dosing valve 112 to provide ammonia to the exhaust assembly. Additionally, or alternatively, intake valve 110 and dosing valve 112 can be configured such that each have respective different connections to an ammonia source (e.g., a reservoir or a pipeline). Dosing valve 112 provides fuel (e.g., ammonia) from fuel reservoir 108 to exhaust assembly 114 prior to exhaust treatment assembly 134 to induce a reaction between the fuel and the exhaust products from reaction section 121.

Since a known issue with nitrous oxide is the inability of SCR catalyst 136 or ASC 138 to catalyze nitrous oxide, the reintroduction of ammonia to the exhaust causes a reaction that yields products that can be catalyzed by exhaust treatment assembly 134 instead of just passing the nitrous oxide through to the exhaust assembly overall. In some embodiments, control computer 104 computes or maps expected amounts of nitrous oxide to be generated during each operational cycle and uses these mapped or computed amounts to drive the amount of ammonia to be introduced into exhaust assembly 114 using dosing valve 112 based on instructions communicated by the transmission of the fuel dosing command using communication channel 146.

Additionally, exhaust content data signal 142, as provided by sensor 140, can also drive the content of the fuel dosing command transmitted using communication channel 146. For example, if excess unreacted ammonia is detected, the transmitted fuel dosing command may cause dosing valve 112 to reduce an opening size or close entirely until subsequent operation of the system results in sensor data indicating there is a need for ammonia to be introduced to exhaust assembly 114. In some embodiments, sensor 140 also provides data indicative of oxygen present in the exhaust products which can be used to estimate the amount of nitrous oxide present in the exhaust products by way of a computational model (e.g., a look up table, simulation of nitrous oxide chemical formation rate equations, or any combination thereof). This oxygen data can also drive the boost air flow command transmitted over communication channel 132 as provided by control computer 104 in order to anticipate a desired air-fuel ratio for an air-fuel mixture to be provided to reaction section 121 in a subsequent operational cycle such that the amount of nitrous oxide in the exhaust products is below some desired limit (e.g., 20 ppm). For example, where more oxygen is detected at sensor 140, there is an assumption the air-fuel ratio from the preceding operational cycle was not ideal and the nitrous oxide computation is updated to cause less boost air flow to be provided to the reaction section 121 by air blower 106.

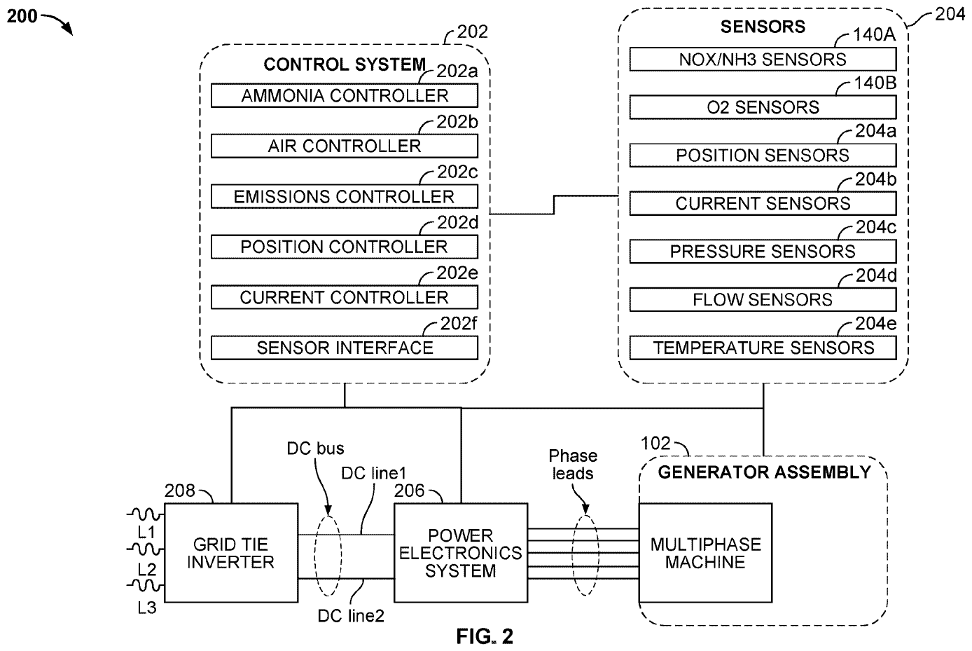

FIG. 2 is a block diagram of linear generator system 200 having control system 202 (e.g., corresponding to control computer 104 of FIG. 1) and sensor array 204 (e.g., including sensor 140 of FIG. 1) in accordance with some embodiments of the present disclosure. Linear generator system 200 also includes generator system 102 of FIG. 1 (e.g., which can be characterized as a multiphase machine considering the electronic phases, or coils, comprising each of stators 124a and 124b), power electronics system 206, and grid tie inverter 208. Control system 202 (e.g., corresponding to control computer 104) includes fuel controller 202a (e.g., an ammonia controller for controlling flow), air controller 202b (e.g., for controlling air flow by the boost air flow command as provided using communication channel 132 of FIG. 1), emissions controller 202c (e.g., for controlling one or more exhaust constituents based on sensor data or a look up table by providing parameters for generating an ideal air-fuel mixture for a subsequent reaction in a subsequent operational cycle), position controller 202d (e.g., for controlling translator position based on actuation of one or more of translators 118a and 118b of FIG. 1), current controller 202d (e.g., for controlling phase currents), and sensor interface 202f (e.g., for communicating with any or all sensors of sensor array 204). Any other suitable controller or control circuitry, or any combination thereof can also be incorporated into linear generator system 200 in order to achieve the desired operational conditions and outputs described in this present disclosure.

Sensor array 204 may at least partially correspond to sensor 140 of FIG. 1 in that sensor array 204 corresponds to one or more sensors for detecting various parameters required for executing one or more methods of this present disclosure. As shown in FIG. 2, sensor array 204 includes NOx/NH3 sensors 140A and oxygen (“O2”) sensors 140B, which can be combined to create sensor 140 of FIG. 1. Sensor array 204 also includes position sensors 204a (e.g., one or more encoders or other suitable sensor architecture for measuring or determining positions of each of translators 118a and 118b of FIG. 1), current sensors 204b (e.g., for monitoring whether power output from one or more of stators 124a or 124b is aligned with the target power output generated by control computer 104 of FIG. 1 by monitoring current in the stator phases), pressure sensors 204c (e.g., for detecting pressure at or around inlet port 126 of FIG. 1), flow sensors 204d (e.g., for monitoring an amount of air, fuel, air-fuel mixture, or exhaust products propagating through different subassemblies of linear generator assembly 102 of FIG. 1), and temperature sensors 204e (e.g., for verifying temperatures of air and gas before reaction, during mixing, and after reaction. Any suitable combination of these sensors may be utilized to achieve the functional architecture for sensor array 204 to achieve the desired reaction and exhaust parameters of this present disclosure. Power electronics system 206 includes transistors, phase leads, DC bus lines (e.g., coupled to grid tie inverter 208), bridge circuits, sensors, control circuitry, and any other suitable components, or any combination thereof, for achieving the desired operational outputs described in this disclosure.

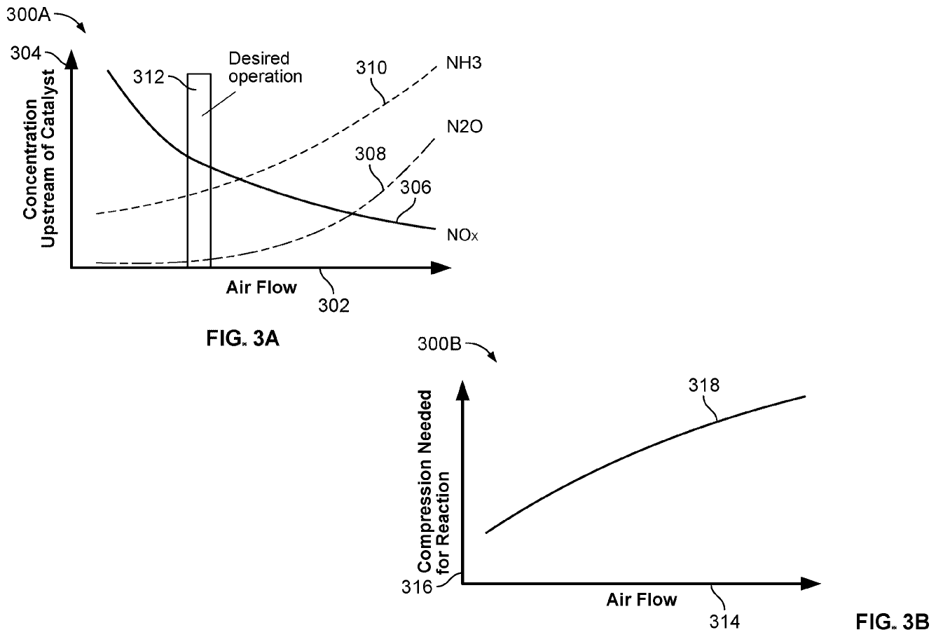

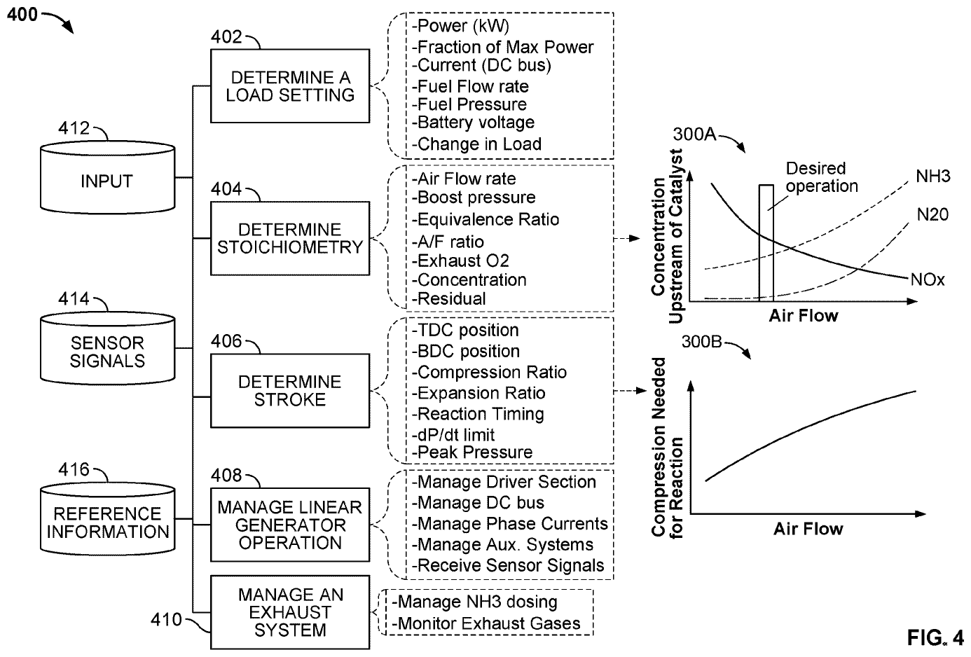

FIGS. 3A and 3B show respective illustrative plots of operating characteristics, in accordance with some embodiments of the present disclosure. Because the flameless reaction in the linear generator occurs substantially or completely uniformly throughout the mixture, as opposed to in a flame front, the extent of reaction completion and NOx formation are dictated by the reaction temperature and amount of dilution of the entire air-fuel mixture. The amount of air flow into the reaction chamber affects the temperature and amount of dilution-more air flow means a cooler, more dilute mixture (dilute meaning additional air relative to the amount of fuel). The resulting amounts of the three most important undesired product species are shown as a function of air flow (for example at a given fuel flow rate or power setting). As air flow is increased, the cooler temperatures result in less NO formation and increased NH3 and N2O concentration.

A further consequence of changing the air flow is that a different amount of compression may be needed to initiate reaction at the optimal timing. The control system causes the linear generator to automatically adjust the degree of compression (e.g., the compression ratio) to achieve the reaction timing for highest efficiency. A reaction control algorithm provides an output for control circuitry to process in order to determine a proper degree of compression for an ideal reaction. Additionally, or alternatively, a control algorithm to assist translators with achieving a desired apex during different operational cycles or piston strokes (e.g., an apex control algorithm) provides an output for control circuitry to process to cause currents of a linear electromagnetic machine (e.g., corresponding to the translator and stator interactions described herein) to assist with translators reciprocating in a cylinder in such a manner to achieve the desired compression to cause an ideal reaction between the two oscillating translators.

As a result of these control aspects being implemented in the linear generators of this disclosure, the type of and concentration of exhaust products generated becoming a function of the air flow within the linear generator, and compression adapting to maintain desired efficiency over a range of air flow rates, the air flow rate provides direct and simple control over the ratio of ammonia to NOx, and species thereof, in the gases flowing out of the generator and into the catalyst. If more ammonia and less NOx is desired, then air flow is increased, with a corresponding automatic increase in compression, and vice versa.

FIG. 3A depicts exhaust content concentration plot 300A. Exhaust content concentration plot 300A includes air flow horizontal axis 302, which represents an amount of air flow that is expected to result in a certain concentration of exhaust products, and concentration upstream of catalyst axis 304, which provides a scale of how much of each exhaust product is expected based on an amount of air flow provided (e.g., when operating linear generator system 100 of FIG. 1). NOx curve 306 characterizes that more air flow reduces the concentration of NOx upstream of a catalyst, as shown and described in reference to the exhaust assembly of FIG. 1. Nitrous oxide curve 308 and ammonia curve 310 characterizes that more air flow can also increase the concentrations of both nitrous oxide and ammonia upstream of the aforementioned catalyst. Desired operation portion 312 characterizes a target amount of air flow to result in preferred concentrations of ammonia, NOx, and nitrous oxide in exhaust upstream of the aforementioned catalyst that is expected to result in a downstream sensor generating a sensor signal indicative of preferred amounts of each of these exhaust products. For example, the amount of air flow defined by desired operation portion 312 is expected to result in an acceptably low value (e.g., corresponding to a magnitude of zero characterizing an amount of exhaust product constituents) for each respective concentration level of each of these products after the exhaust propagates through an exhaust treatment assembly.

FIG. 3B depicts compression required for reaction plot 300B. Compression required for reaction plot 300B includes air flow horizontal axis 314, which represents an amount of air flow that is expected for a given piston stroke or linear generator operational cycle, and compression magnitude vertical axis 316, which provides a scale of how much compression is needed within a reaction chamber for achieving an optimum, or preferred, reaction (e.g., a reaction that involves reacting majority or all fuel of an air-fuel mixture without producing detectable, or operationally significant, amounts of undesired exhaust products) relative to a given amount of air flow used to create an air-fuel mixture for operating a linear generator (e.g., corresponding to linear generator system 100 of FIG. 1). Compression curve 318 characterizes that more air flow generally requires a higher amount of compression for an ideal reaction. Accordingly, a control computer of this disclosure can rely on desired operation portion 312 of FIG. 3A to identify an amount of air flow for a particular cycle, or cycles, and then can rely on compression curve 318 to determine an amount of desired compression for the amount of air flow to be provided in order to control translator trajectories, or positions, for an ideal (e.g., one or more of desired, target, or preferred) compression reaction of an air-fuel mixture in a reaction section. In some embodiments, the linear generators of this disclosure utilize, or operate based on, flameless reactions (e.g., as may be achieved using compression reactions).

The linear generators of this disclosure can achieve a variable compression ratio based on various ways to control the ratio of a volume of the reaction sections of this disclosure as compared to a displacement volume of translators of this disclosure. The flexibility of being able to achieve the variable compression ratio (e.g., by controlling apexes of translator motion within a cylinder) assists the systems of this disclosure with operating based on flameless reactions and compression ignition, for example. By controlling apexes of the translators, both the displacement volume as well as the volume of the reaction section between two translators can be controlled. In some embodiments, the range of compression ratios of systems of this disclosure can be a ratio as small as 2 and as large as 100. In some embodiments, the compression ratio corresponds to an ideal operating range (e.g., as defined by compression curve 318 or as defined by desired operation portion 312 of FIG. 3A). When subjected to ideal or target conditions, the compression ratio may be adjust in a range as small as 20-35 or 15-40.

In some circumstances, nitrous oxide should be minimized because it is a strong greenhouse gas, and it cannot be removed by either a SCR catalyst or an ASC. Accordingly, in some embodiments, the present disclosure provides the ability to operate in a region where minimal nitrous oxide (e.g., less than 20 ppm) is formed in the reaction itself. The resulting desired operating region represented by desired operation portion 312 of FIG. 3A depicts a curve representing the amount of nitrous oxide asymptotically approaching zero closer to the lower end of the air flow region included in desired operation portion 312. In this region, there is slightly more NOx than ammonia present in exhaust products prior to propagating towards the catalysts of FIG. 1.

In some embodiments, for ideal conversion in the SCR catalyst, the catalyst inlet should have equal molar concentrations of ammonia and NOx. A second control input, such as supplemental dosing of ammonia from the fuel line using dosing valve 112 of FIG. 1, provides the needed additional ammonia to the catalyst in order to result in an exhaust product consisting of desired concentrations of certain constituents (e.g., zero or minimal levels of ammonia and species of NOx). In some embodiments, a branch from the main fuel line feeds to an electronically actuated valve with an adjustable flow rate (e.g., as characterized by dosing valve 112 and the flow of ammonia from fuel reservoir 108 to exhaust assembly 114 as shown in FIG. 1). A small amount (e.g., less than 1%) of the ammonia fuel input flows through this valve, and to the catalyst.

In some embodiments, a sensor (e.g., sensor 140 of FIG. 1) in contact with the gas flow at the outlet of the catalyst measures the total amount of NOx (e.g., including various species thereof) and an ammonia concentration in the exhaust gas. An example of this type of sensor is an electrochemical sensor. The control computer for the generator receives and processes the output from this sensor, and controls the air flow rate to a linear generator and the ammonia dosing valve flow rate to achieve desired or minimum emissions of NOx, ammonia, and nitrous oxide at the catalyst outlet.

One exemplary control strategy is to set the ammonia dosing valve flow rate from a predetermined map as a function of a generator load setpoint or other external factors. In this example control strategy, the ammonia dosing valve flow rate is connected to a generator load setpoint (e.g., a target power output) based at least in part on the desire to minimize certain exhaust product constituents. As a certain amount of ammonia is mixed with air to create an air-fuel mixture to react, additional ammonia is dosed into the exhaust product of the reaction as the exhaust product propagates towards an exhaust treatment assembly (e.g., exhaust treatment assembly 114 of FIG. 1). Accordingly, the dosing flow rate would be determined based on chemical considerations for preferred amounts of certain exhaust products being produced after each reaction (e.g., where certain chemical compounds are in the range of near-zero as an exhaust product constituent, those certain chemical compounds including nitrous oxide). For example, the range may be determined and then the dosing rate may be retrieved based on reference information (e.g., a predetermined map). The controller would adjust the air flow rate in real time or near real time to fine-tune the content of exhaust products that are provided to the SCR catalyst for post reaction treatment of the exhaust product and achieve a minimum reading of unwanted exhaust in the outlet stream. Other control strategies are possible that use air flow to the reaction section and dosing valve flow as variables to adjust based on sensor measurement data at the exhaust.

Another control strategy is, for a given ammonia fuel flow rate/generator load setpoint, set the air flow rate to be in the range of near-zero nitrous oxide production with a resulting NOx to ammonia ratio exiting the reaction chamber. This corresponds to an air flow rate towards the left side of desired operation portion 312 of FIG. 3A. This air flow rate may be determined based on a predetermined map (e.g., a computed correlation between an amount of air to provide to mix with a fuel, such as ammonia, to create a target air-fuel ratio in an air-fuel mixture to be provided to a reaction section for reaction in order to generate one or more of an electrical power output or a target pressure that causes translators to achieve a one or more of a desired velocity, desired position, or desired acceleration as part of continuous operation of a linear generator) in conjunction with closed-loop feedback from the sensor (e.g., sensor 140). The dosing flow rate would then be adjusted to reduce the excess NOx, and species thereof, in the exhaust products until the sensor in the exhaust assembly (e.g., exhaust assembly 114) collects data characterizing the chemical content of the exhaust product for producing a signal indicative of undesired exhaust product constituents not exceeding a maximum preferred quantity relative to the overall volume of exhaust product produced (e.g., corresponding to a target level such as zero unpreferred exhaust product constituents).

In some embodiments, a variant of the control strategies discussed above may incorporate a model-predictive algorithm for more rapid and precise temporal response to generator operating transients such as those induced by fluctuating power demand. In such a strategy, instead of waiting for feedback from the sensor and for the relatively long physical time constants in the exhaust aftertreatment system to settle out, the model-predictive algorithm uses a real-time model of the catalyst beds of an exhaust treatment assembly in conjunction with a model of the reaction chamber outputs to predictively set the ammonia dosing valve flow rate. The net impact would be that the total NOx concentration, and species thereof, as well as the ammonia concentration in the exhaust outlet stream remains within design limits even as the exhaust catalyst system ramps through operating transients.

In some embodiments, it may be necessary for the control strategy to manage the temperature within the catalyst beds. In situations where the exhaust stream exiting the reaction chamber may not contain sufficient enthalpy for the catalysts to maintain temperatures needed for adequate conversion of NOx, and species thereof, as well as for conversion efficiency, the control strategy may respond by further reducing the air flow rate to increase the inlet temperature to the catalysts. Any further imbalance in the NOx to ammonia ratio entering the catalysts would be reduced by the ammonia dosing valve. Each of these control strategies can be modified based on the use of fuels different from ammonia in order to reduce concentrations of undesired exhaust products that may be different from those listed herein.

FIG. 4 is a flowchart of process 400 for controlling a linear generator operating on ammonia or other fuel, in accordance with some embodiments of the present disclosure. Process 400 includes process block 402 for determining a load setting (e.g., using control computer 104 of FIG. 1). Determining the load setting may include, for example, determining power (e.g., in terms of heating value of fuel, electrical generation, or other metric), fraction of a maximum power (e.g., a percentage), a DC bus current, a fuel flow rate, a fuel pressure (e.g., corresponding to a fuel flow rate), a battery voltage (e.g., when charging), any other suitable load metric or change thereof, or any combination thereof.

Process 400 also includes process block 404 for determining stoichiometry, (e.g., using control computer 104 of FIG. 1). Determining stoichiometry may include, for example, determining an air flow rate, a boost pressure (e.g., corresponding to an air flow rate), an equivalence ratio, an air-fuel ratio, an exhaust O2 amount (e.g., based on an O2 sensor measurement), a concentration of a particular reactant or product, an amount of residual (e.g., after scavenging), any other suitable metric indicative of the reactant mixture, any other suitable metric indicative of the product mixture, or any combination thereof. Determining stoichiometry at block 404 may include relying on the relationship characterized by exhaust content concentration plot 300A of FIG. 3A.

At process block 406, a control computer of this disclosure can receive instructions to determine stroke characteristics. Determining stroke characteristics may include, for example, determining a top-dead-center (TDC) position (e.g., for each translator), a bottom-dead-center (BDC) position (e.g., for each translator), a stroke length (e.g., a difference between actual or desired TDC and BDC), reaction timing (e.g., as determined by the expected achievement of TDC by respective translators propagating towards each other to cause reaction an air-fuel mixture in a reaction section based on compression of the air-fuel mixture achieved between the respective translators), pressure increase (e.g., rate of pressure rise may correspond to reaction timing), peak pressure, any other suitable metric indicative of stroke, any other metric indicative of reaction timing, or any combination thereof. Determining stroke characteristics at block 406 may include relying on the relationship characterized by exhaust content concentration plot 300A of FIG. 3A.

At process block 408, a control computer of this disclosure can receive instructions to control operation of a linear generator of this disclosure. Controlling linear generator operation may include, for example, controlling a driver section (e.g., an amount of gas in a gas spring, a compression ratio, a peak pressure), controlling a DC bus (e.g., coupled to an inverter), controlling phase currents (e.g., of phase leads coupled to one or more stators of the linear generator), controlling auxiliary systems (e.g., cooling, air, fuel, intake, exhaust, bearing, electronics, or sensor systems), receiving sensor signals, any other suitable actions, or any combination thereof.

At process block 410, a control computer of this disclosure can receive instructions to control an exhaust system of a linear generator of this disclosure. Controlling the exhaust system may include, for example, controlling ammonia dosing (e.g., by controlling a flow rate), monitoring exhaust gases (e.g., concentrations or ratios thereof, temperatures pressure dynamics), any other suitable actions affecting gases exiting exhaust ports of the linear generator, or any combination thereof.

The system (e.g., by way of control computer 104) may access reference information such as computer instructions, parameter values, operating maps, databases or other structured data, historical or previous operating data (or statistical derivations thereof), expected values, calibration values, identification information (e.g., component IDs or serial numbers), any other suitable information, or any combination thereof. Any of process blocks 402-410 can be utilized independently or collectively, or any combination thereof, for any individual operational cylinder of a linear generator. For example, input information 412, sensor signals 414, reference information 416, or any other suitable information may be used to control operation of the linear generator. Control computer 104 can, for example, utilize any or all of this information to perform any of the functions described in reference to each of blocks 402-410. Control computer 104 can be configured to process instructions to perform any of the functions of each of process blocks 402-410 for each of translators 118a and 118b of FIG. 1 independent of each other, or additionally or alternatively, depending on the conditions experienced during each operational cycle, for the pair of translators collectively (e.g., presuming there is synchronization in motion or trajectories between the translators).

It will be understood that the principles of the present disclosure can be applied to any suitable type of generator or generator system, including, for example internal combustion (hereinafter “IC”) engines, gas turbines, boilers feeding steam turbines, and heat engines, such as a Stirling engine. All of these devices share in common a reaction process having a flame structure that propagates the reaction through the available quantity of fuel and air. For example, in a spark-ignited (hereinafter “SI”) IC engine, a spark plug starts reaction in a small local region, and then a flame propagates from the spark location throughout the rest of the chamber. In a gas turbine, a boiler, or a heat engine, careful design of the air and fuel flow pattern in a burner creates a flame-holding zone where the flame propagation speed matches the flow speed, and so incoming fuel and air meet with high-temperature products in a stabilized flame front.

In all of these cases, the flame properties are dependent on the fuel type, as well as on the relative amounts of fuel and air (e.g., the concentration of fuel in air). For example, if the fuel concentration is too low in an SI IC engine, the flame speed decreases, and the flame will not propagate across the chamber in time to completely react all of the fuel. In a burner, if the concentration and therefore the flame speed decreases, the flame can ‘blow off’ the burner and extinguish. Conversely if the flame speed is too high, the flame can work upstream into the burner and damage components. The result of this physical constraint is that, for a given hardware geometry in any of these devices, the reaction process only functions in a relatively narrow range of fuel/air ratio.

The reaction in a linear generator as provided by the present disclosure in some embodiments does not have a flame structure. The fuel and air are uniformly mixed throughout the chamber, and then the temperature of that mixture is raised uniformly via compression until reaction occurs throughout the chamber. Unique to a linear generator, the magnitude and timing of that compression is precisely adjustable in real time. A relevant consequence of this lack of flame, and adjustable compression, is that the reaction can proceed effectively (e.g., corresponding to a desired quantified efficiency value for operation of the linear generator systems of this disclosure) over a wide range of fuel/air ratios. For example, if a lower fuel concentration is desired, the air flow may be increased for the same fuel flow. In that case, the needed amount of compression increases, and the generator automatically increases the amount of compression until the reaction proceeds as desired. Conversely, a higher concentration may be achieved by decreasing air flow, accompanied by a decrease in compression to return the onset of reaction to the optimal timing. Additionally, the lack of a flame renders the change in flame speed unimportant for the linear generator. For example, the liner generators of this disclosure can be configured to operate using a flameless reaction of an air-fuel mixture in a reaction section. Controlling of air flow, as described in reference to FIGS. 3A and 3B, can also be used to control reactions based on compression in order to generate exhaust content including preferred levels of certain species of exhaust constituents and preferred ratios thereof.

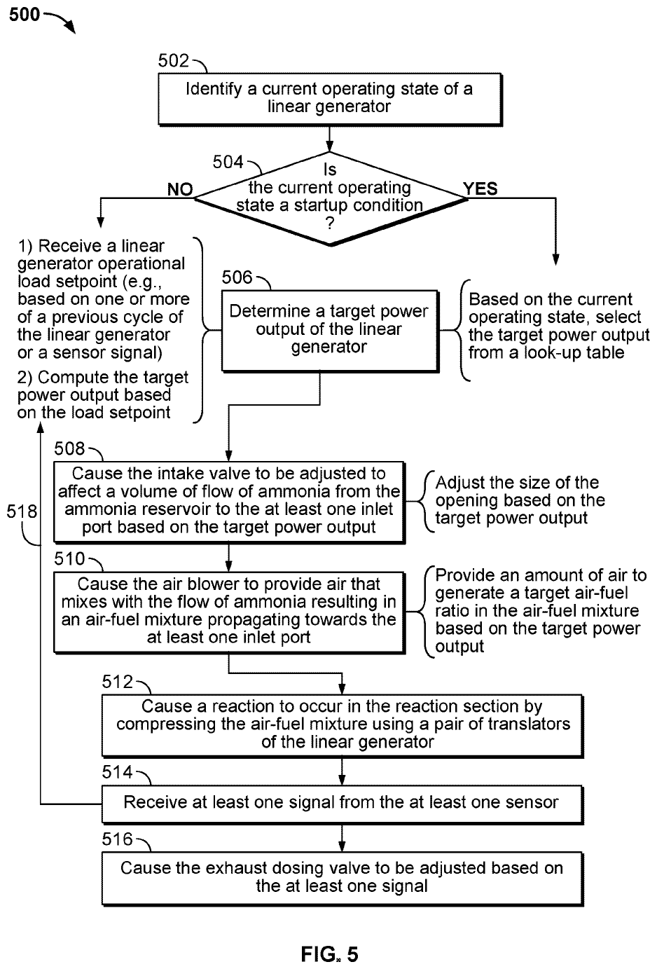

FIG. 5 is a flowchart of illustrative process 500 for operating a linear generator based on compression of an air-fuel mixture (e.g., based on a desired ratio of air and ammonia) to control content of the exhaust generated from the reaction in accordance with some embodiments of the present disclosure. Process 500 can be executed as computer readable instructions processed by control circuitry of a linear generator system (e.g., using control computer 104 of FIG. 1).

Process 500 includes process block 502 for identifying a current operating state of a linear generator. The current operating state can include being off, being in a startup condition, being idle, being in a power output mode, or any combination thereof including indications of which control algorithms of this disclosure are active and influencing cycle by cycle operation of one or more components of the linear generators of this disclosure. Decision block 504 is utilized to determine if the current operating state of the linear generator is a startup condition. If the linear generator is determined to be in a startup condition (YES at 504), process block 506 is used to determine the target power output comprises determining the target power output based on predictive operational parameters (e.g., a look up table generated based on expected operational conditions of the linear generator considering known measured parameters such as a fuel type and available compression as described in this disclosure). If the linear generator is determined to no longer be in a startup condition (NO at 504), process block 506 is used to determine one or more of a target power output, or an updated target power output, based on one or more of a previous cycle of the linear generator or at least one signal from at least one sensor (e.g., sensor 140 of FIG. 1).

Determining the target power output of the linear generator can include receiving a linear generator operational load set point. The load setpoint can be one or more of a piston position-force trajectory, a piston compression load, or an electrical power output of a stator coil of a linear generator. In some embodiments, the target power output can be determined based on a power meter (e.g., as defined by a campus with multiple structures or devices that draw power from one or more linear generator systems of this disclosure). For example, a grid-tie inverter for a particular device or campus can be configured to define one or more of a grid frequency or a voltage to be generated based on operation of the one or more linear generator systems of the present disclosure.

At process block 508, a control computer, or control circuitry, causes an intake valve of this disclosure to be adjusted to affect a volume of flow of ammonia from the ammonia reservoir to the at least one inlet port based on the target power output. In some embodiments, the intake valve comprises an opening and the intake valve is configured to be adjusted by changing a size of the opening. Process block 508 can, for example, include adjusting the size of the opening based on the target power output. At process block 510, the control computer, or control circuitry, causes the air blower to provide air that mixes with the flow of ammonia resulting in an air-fuel mixture propagating towards the at least one inlet port. In some embodiments, process block 510 causes the air blower to provide an amount of air to generate a target air-fuel ratio in the air-fuel mixture based on the target power output. At process block 512, a reaction is caused to occur in the reaction section by compressing the air-fuel mixture using the pair of translators (e.g., using a control algorithm for piston position or piston apex control). At process block 514, at least one signal from the at least one sensor is received. At process block 516, the exhaust dosing valve is caused to be adjusted based on the at least one signal.

In some embodiments, the intake valve can be caused to be adjusted via process block 508 based on an updated target power output generated in response to the at least one signal, as represented by process loop 518. Additionally, or alternatively, process blocks 506 through 514 can be repeated with iterative adjustments to the dosing caused by process block 516 until the at least one signal of the at least one sensor indicate that a criterion for exhaust content has been met. For example, the criterion can be based on respective levels of one or more of ammonia or NOx in the exhaust content (e.g., preferably as close to a concentration of zero for each exhaust constituent as possible while achieving a target power output).

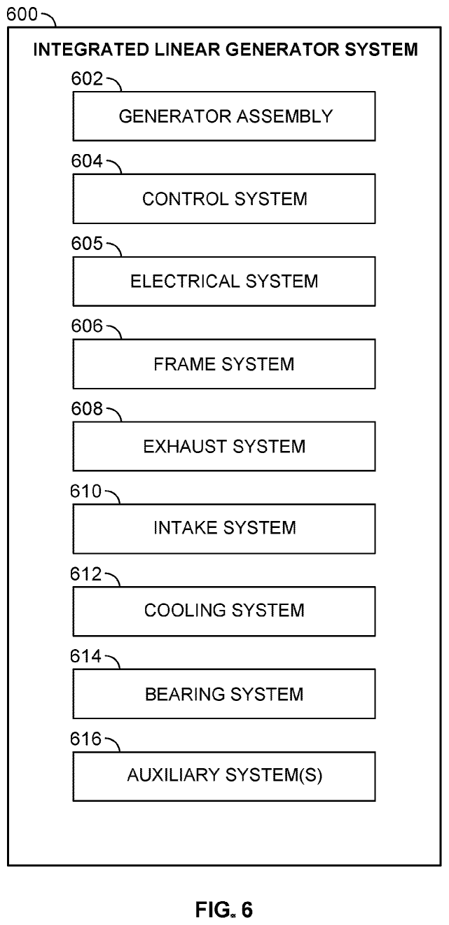

FIG. 6 shows a system diagram of integrated linear generator system 600, in accordance with some embodiments of the present disclosure. Integrated linear generator system 600 can incorporate, or be incorporated into, linear generate system 100 of FIG. 1 or the system of FIG. 2.

Integrated linear generator system 600 includes generator assembly 602, control system 604, electrical system 605, frame system 606, exhaust system 608, intake system 610, cooling system 612, bearing system 614, and auxiliary system(s) 616. Generator system 600 is configured to generate and control electric power as controlled by control system 604 and electrical system 605. In some embodiments, electrical system 605 includes both low-voltage and high-voltage components. For example, electrical system 605 may include 480 VAC components (e.g., grid or grid-tied components, auxiliary components), 120 VAC components/circuits (e.g., auxiliary components), a high voltage DC bus and components (e.g., >400 VDC, >700 VDC, or >1000 VDC components), a low voltage DC bus and components (e.g., 12 VDC, 24 VDC, or 48 VDC components), low voltage DC components (e.g., 12 VDC, 24 VDC, or 48 VDC components), any other suitable electrical circuits operating with any suitable voltage and current characteristics, or any combination thereof. Intake system 610 is configured to provide reactants (e.g., air, fuel, or both) to generator assembly 602, and exhaust system 608 is configured to remove exhaust products from generator assembly 602. Cooling system 612 is configured to limit, control, or otherwise affect, heat transfer and material temperature of components of integrated linear generator system 600. Bearing system 614 is configured to constrain the off-axis motion (e.g., radial, lateral, or otherwise lateral motion) of translators of generator assembly 602 using, for example, a low-friction gas bearing. Frame system 606 is configured to control rigidity, flexibility, and alignment of components of integrated linear generator system 600. The divisions between, or combination of, systems 602-614 may be implemented in any suitable arrangement and are shown as separate in FIG. 6 for purposes of the following description. For example, any suitable components of control system 604, electrical system 605, frame system 606, bearing system 614, intake system 610, exhaust system 608, and cooling system 612 may be integral to generator assembly 602. Auxiliary system(s) 616 may include any suitable system or subsystem configured to support operation of integrated linear generator system 600.

It will be understood that system 600 is merely illustrative. Any suitable combination of subsystems may be used, including those that contain fewer or more than what is shown in FIG. 6. Generator assembly 602 includes, for example, the moving and stationary assemblies and components that are configured to convert chemical and/or thermal energy into electrical energy. In some embodiments, generator assembly 602 includes cylinders, translators, stators, bearings, bearing housings, seals, corresponding alignment hardware, any other suitable components, or any suitable combination thereof. In some embodiments, generator assembly 602 is configured to perform a thermodynamic cycle such as, for example, a chemical engine cycle. An illustrative example includes a two-stroke piston engine cycle using compression ignition and port breathing via uniflow scavenging (e.g., intake ports at a first axial end and exhaust ports arranged at a second axial end, wherein scavenging occurs primarily axially). In a further example, generator assembly 602 may be configured to perform a cycle approximating, for example, an Otto cycle, a Diesel cycle, an Atkinson cycle, a Miller cycle, a Carnot cycle, an Ericsson cycle, a Stirling cycle, any other suitable idealized or actual cycle, or any suitable combination thereof.

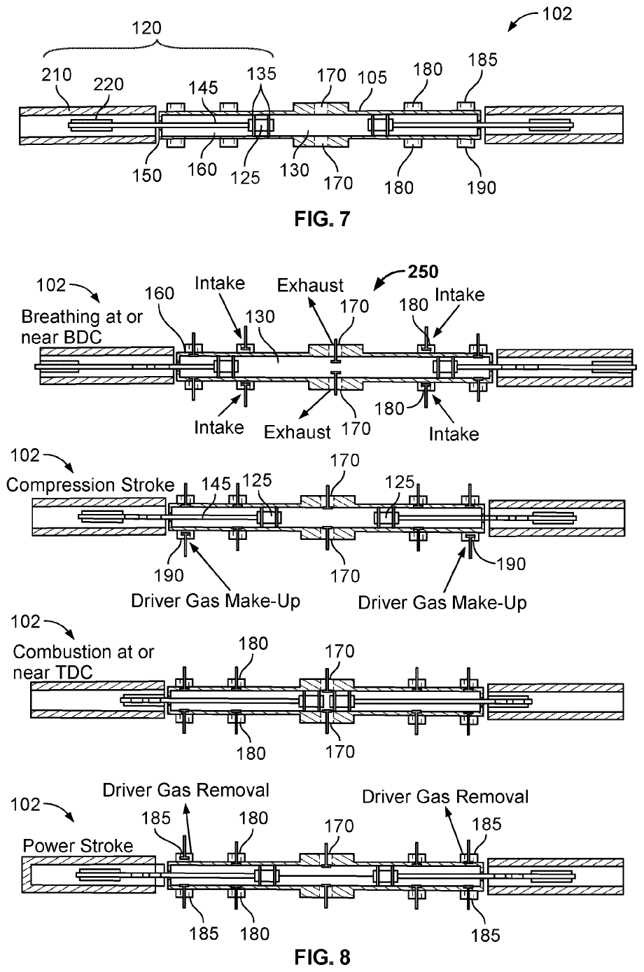

FIG. 7 is a cross-sectional drawing illustrating a two-piston, two-stroke, integrated gas springs embodiment of linear generator assembly 102 of FIG. 1, in accordance with the principles of the invention.

Linear generator assembly 102 directly converts the chemical energy in a fuel into electrical energy via a pair of linear electromagnetic machines. As used herein, the term “fuel” refers to matter that reacts with an oxidizer. Such fuels include, but are not limited to: (i) hydrocarbon fuels such as natural gas, biogas, gasoline, diesel, and biodiesel; (ii) alcohol fuels such as ethanol, methanol, and butanol; (iii) hydrogen; (iv) ammonia; and (v) mixtures of any of the above. The linear generator assemblies described herein are suitable for both stationary power generation and portable power generation (e.g., for use in vehicles).

Linear generator assembly 102 comprises one cylinder 105 with two opposed translators 120 that meet at a reaction section 130 (or reaction chamber) in the center of the cylinder 105. The placement of the reaction section 130 in the center of the linear generator assembly 102 balances the reaction forces. Each translator 120 comprises a piston 125, piston seals 135, a piston rod 145, and magnet assembly 220. Note that the opposing translator and features on the opposite side of FIG. 7 are not numbered. In some embodiments, the translator may have a piston at both ends of the piston rod, such as gas spring pistons 115a and 115b of FIG. 1. The translators 120 are free to move linearly within the cylinder 105. The piston rods 145 move along bearings and are sealed by gas seals 150 that are fixed to the cylinder 105 and the LEM. In the illustrated embodiment, the gas seals 150 are piston rod seals. As used herein, the term “bearing” refers to any part of a machine on which another part moves, slides, or rotates, including but not limited to slide bearings, flexure bearings, ball bearings, roller bearings, gas bearings, and/or magnetic bearings. Additionally, the term “surroundings” refers to the area outside of the cylinder 105, including but not limited to: the immediate environment, auxiliary piping, and/or auxiliary equipment.

The volume between the backside of translator 125, piston rod 145, and the cylinder 105 is referred to herein as the driver section 160 (in some embodiments, the driver section may be outboard of the LEM; for example, in FIG. 1 the driver sections are 116a and 116b). The driver section 160 may also be referred to herein as the “gas section”, “gas springs” or “gas springs section.” Each driver section 160 is sealed from the surroundings and reaction section 130 by piston rod seal 150 and piston seals 135. In some embodiments only a single piston seal is used. In the illustrated embodiment, the gas in the driver section 160 acts as a fly wheel (i.e., a gas spring) during a cycle to provide at least some of the compression work during a compression stroke. Accordingly, some embodiments of the invention feature gas springs for providing work. Other embodiments include a highly efficient linear alternator operated as a motor, and do not require gas springs for generating compression work.

In some embodiments, in order to obtain high thermal efficiencies, the linear generator assembly 102 has a variable expansion ratio greater than 50:1. In additional embodiments, the variable expansion ratio is greater than 75:1. In further embodiments, the variable expansion ratio is greater than 100:1. In addition, some embodiments feature a compression ratio equal to or less than the expansion ratio, and a reaction section length at TDC between 0.2-4 inches. As used herein, “reaction section length at TDC” is the distance between the front faces of the two translators 125 at TDC.

The above specifications dictate that the linear generator assembly 102 have a stroke length that is significantly longer than in conventional linear generator assemblies, wherein the term “stroke length” refers to the distance traveled by the each piston 125 between TDC and BDC. Reaction ignition can be achieved via compression ignition and/or spark ignition. Fuel can be directly injected into the reaction chamber 130 via fuel injectors (“direct injection”) and/or mixed with air prior to and/or during air intake (“premixed injection”). The linear generator assembly 102 can operate with lean, stoichiometric, or rich reaction using liquid and/or gaseous fuels.

Cylinder 105 includes exhaust ports 170, intake ports 180, driver gas removal ports 185, and driver gas make-up ports 190, for exchanging matter (solid, liquid, gas, or plasma) with the surroundings. As used herein, the term “port” includes any opening or set of openings (e.g., a porous material) which allows matter exchange between the inside of the cylinder 105 and its surroundings. Some embodiments do not require all of the ports depicted in FIG. 7. The number and types of ports depends on the linear generator assembly configuration, injection strategy, and piston cycle (e.g., two- or four-stroke piston cycles). For example, in some embodiments, the driver 150 only has make-up ports and no removal ports. Other embodiments have an injector port in the cylinder or near the intake ports. For this two-piston, two-stroke embodiment, exhaust ports 170 allow exhaust gases and fluids to leave the cylinder, intake ports 180 are for the intake of air and/or air/fuel mixtures, driver gas removal ports 185 are for the removal of driver gas, and driver gas make-up ports 190 are for the intake of make-up gas for the driver section 160. The location of the various ports is not necessarily arranged as shown in FIGS. 7-8. For example, in the illustrated embodiment, exhaust ports 170 are located substantially at the midpoint of the cylinder. However, these ports may alternatively be located away from the midpoint and adjacent to intake ports 180, or they may be located at the opposite end of the cylinder as compared to the intake ports, as shown in FIG. 1.

The above-described ports may or may not be opened and closed via valves. The term “valve” may refer to any actuated flow controller or other actuated mechanism for selectively passing matter through an opening, including but not limited to ball valves, plug valves, butterfly valves, choke valves, check valves, gate valves, leaf valves, piston valves, poppet valves, rotary valves, slide valves, solenoid valves, 2-way valves, or 3-way valves. Valves may be actuated by any means, including but not limited to mechanical, electrical, magnetic, camshaft-driven, hydraulic, or pneumatic means. In most cases, ports are required for exhaust, driver gas removal, and driver gas make-up. In embodiments where direct injection is the desired ignition strategy, injector ports and air intake ports are also required. In embodiments where premixed compression ignition or premixed spark ignition is the desired reaction strategy, air/fuel intake ports may also be required. In embodiments where a hybrid premixed/direct injection strategy with compression ignition and/or spark ignition is the desired reaction strategy, injector ports and air/fuel intake ports may also be required. In all linear generator assembly configurations, exhaust gas from a previous cycle can be mixed with the intake air or air/fuel mixture for a proceeding cycle. This process is called exhaust gas recirculation (EGR) and can be utilized to moderate reaction timing and peak temperatures.

Linear generator assembly 102 further comprises a pair of linear electromagnetic machines (LEMs) 200 for directly converting the kinetic energy of the translators 120 into electrical energy. Each LEM is also capable of directly converting electrical energy into kinetic energy of the translator 120 for providing compression work during a compression stroke. As illustrated, the LEM comprises a stator 210 and a translator 120. The translator 120 comprises a magnet assembly 220 that is attached to the piston rod 145 and moves linearly within the stator 210, which is stationary. The radial volume between the magnet assembly 220 and stator 210 is called the air gap. The LEM may include any number of configurations. FIG. 7 shows one configuration in which the magnet assembly 220 is shorter than stator 210. However, the magnet assembly 220 could be longer than the stator 210, or they could be substantially the same length. In addition, the LEM can be a permanent magnet machine, an induction machine, a switched reluctance machine, or some combination of the three. The stator 210 and magnet assembly 220 can each include magnets, coils, iron, or some combination thereof. Since the LEM directly transforms the kinetic energy of the pistons to and from electrical energy (i.e., there are no mechanical linkages), the mechanical and frictional losses are minimal compared to conventional engine-generator configurations.

A diagram illustrating the two-stroke piston cycle 250 of the two-piston integrated gas springs linear generator assembly 102 of FIG. 7 is illustrated in FIG. 8. As used herein, the term “piston cycle” refers to any series of piston movements which begin and end with translator 125 in substantially the same configuration. One common example is a four-stroke piston cycle, which comprises an intake stroke, a compression stroke, a power (expansion) stroke, and an exhaust stroke. Additional alternate strokes may form part of a piston cycle as described throughout this disclosure. A two-stroke piston cycle is characterized as having a power (expansion) stroke and a compression stroke.

FIG. 8 is a diagram illustrating the two-stroke piston cycle of the two-piston integrated gas springs linear generator assembly of FIG. 7. As illustrated in FIG. 8, the linear generator assembly exhausts reaction products (though exhaust ports 170) and intakes air or an air/fuel mixture or an air/fuel/reaction products mixture (through intake ports 180) near BDC between the power and compression strokes. This process may be referred to herein as “breathing” or “breathing at or near BDC.” It will be appreciated by those of ordinary skill in the art that many other types of port and breathing configurations are possible without departing from the scope of the invention. When at or near BDC, and if the driver section is to be used to provide compression work, the pressure of the gas within the driver section 160 is greater than the pressure of reaction section 130, which forces the translators 125 inwards toward each other. The gas in the driver section 160 can be used to provide at least some of the energy required to perform a compression stroke. The LEM may also provide some of the energy required to perform a compression stroke.

The amount of energy required to perform a compression stroke depends on the desired compression ratio, the pressure of the reaction section 130 at the beginning of the compression stroke, and the mass of assembly 120. A compression stroke continues until reaction occurs, which is at a time when the velocity of translator 125 is at or near zero. The point at which the velocities of the translators 125 are equal to zero marks their TDC positions for that cycle. Reactions (e.g., compression caused reactions or spark ignition reactions) cause an increase in the temperature and pressure within the reaction section 130, which forces translator 125 outward toward the LEM. During a power stroke, a portion of the kinetic energy of the assembly 120 is converted into electrical energy by the LEM and another portion of the kinetic energy does compression work on the gas in the driver section 160. A power stroke continues until the velocities of the translators 125 are zero, which marks their BDC positions for that cycle.

FIG. 8 illustrates one port configuration for breathing in which the intake ports 180 are in front of both pistons near BDC and the exhaust ports 170 are near TDC. There are various possible alternative port configurations, such as, but not limited to, locating the exhaust ports 170 in front of one piston 125 near BDC, and locating the intake ports 180 in front of the other translator 125 near BDC (e.g., as shown in FIG. 1 by the arrangements of translators 118a and 118b)—allowing for what is called uni-flow scavenging, or uni-flow breathing. The opening and closing of the exhaust ports 170 and intake ports 180 are independently controlled. The location of the exhaust ports 170 and intake ports 180 can be chosen such that a range of compression ratios and/or expansion ratios are possible. The times in a cycle when the exhaust ports 170 and intake ports 180 are activated (opened and closed) can be adjusted during and/or between cycles to vary the compression ratio and/or expansion ratio and/or the amount of reaction product retained in the reaction section 130 at the beginning of a compression stroke. Retaining reaction gases in the reaction section 130 is called residual gas trapping (RGT) and can be utilized to moderate reaction timing and peak temperatures.

During the piston cycle, gas could potentially transfer past the piston seals 135 between the reaction section 130 and driver section 160. This gas transfer is referred to as “blow-by.” Blow-by gas could contain air and/or fuel and/or reaction products. The linear generator assembly 102 is designed to control blow-by gas by having at least one port in each driver section 160. For example, in the embodiment shown in FIGS. 7 and 8, there is one port 185 for removing driver gas and the another port 190 for providing make-up driver gas. The removal of driver gas and the intake of make-up driver gas are independently controlled and occur in such a way to minimize losses and maximize efficiency.

FIG. 8 shows one strategy for exchanging driver gas in which the removal of driver gas occurs at some point during the expansion stroke and the intake of make-up driver gas occurs at some point during the compression stroke. The removal and intake of driver gas could also occur in the reverse order of strokes or during the same stroke. Removed driver gas can be used as part of the intake for the reaction section 130 during a proceeding reaction cycle. The amount of gas in the driver section 160 can be adjusted to vary the compression ratio and/or expansion ratio. The expansion ratio is defined as the ratio of the volume of reaction section 130 when the translators 125 have zero velocity after the power stroke to the volume of the reaction section 130 when the translators 125 have zero velocity after the compression stroke. The compression ratio is defined as the ratio of the volume of the reaction section 130 when the pressure within the reaction section 130 begins to increase due to the inward motion of the translators 125 to the ratio of the volume of the reaction section 130 when the translators 125 have zero velocity after the compression stroke.

Reaction is optimally controlled by moderating (e.g., cooling) the temperature of the gas within the reaction section 130 prior to reaction. Temperature control can be achieved by pre-cooling the reaction section intake gas and/or cooling the gas within the reaction section 130 during the compression stroke. Optimal reaction occurs when the reaction section 130 reaches the volume at which the thermal efficiency of the linear generator assembly 102 is maximized. This volume is referred to as optimal volume, and it can occur before or after TDC. Depending on the reaction strategy (ignition and injection strategy), the reaction section intake gas could be air, an air/fuel mixture, or an air/fuel/reaction products mixture (where the reaction products are from EGR and/or recycled driver gas), and the gas within the reaction section 130 could be air, an air/fuel mixture, or an air/fuel/reaction products mixture (where the reaction products are from EGR and/or RGT and/or recycled driver gas).

When compression ignition is the desired ignition strategy, optimal reaction is achieved by moderating the temperature of the gas within the reaction section 130 such that it reaches its auto-ignition temperature at the optimal volume. When spark ignition is the desired ignition strategy, optimal reaction is achieved by moderating the temperature of the gas within the reaction section 130 such that it remains below its auto-ignition temperature before a spark fires at optimal volume. The spark is externally controlled to fire at the optimal volume. The reaction section intake gas can be pre-cooled by means of a refrigeration cycle or by a heat exchanger that is cooled by ambient air drawn in by a fan. The gas within the reaction section 130 can be cooled during a compression stroke by injecting a liquid into the reaction section 130 which then vaporizes. The liquid can be water and/or another liquid such as, but not limited to, a fuel or a refrigerant. The liquid can be cooled prior to injection into the reaction section 130.

For a given linear generator assembly geometry and exhaust and intake port locations, the power output from the linear generator assembly 102 can be varied from cycle to cycle by varying the air/fuel ratio and/or the amount of reaction products in the reaction section 130 prior to reaction and/or the compression ratio and/or the expansion ratio. For a given air/fuel ratio in a cycle, the peak reaction temperature can be controlled by varying the amount of reaction products from a previous cycle that are present in the reaction section gas prior to reaction. Reaction products in the reaction section gas prior to reaction can come from EGR and/or RGT and/or recycling driver gas. Piston synchronization is achieved through a control strategy that uses information about the piston positions, piston velocities, reaction section composition, and cylinder pressures, to adjust the LEMs' and driver sections' operating characteristics.

The configuration of FIGS. 7 and 8 includes a single unit referred to as the linear generator assembly 102 and defined by the cylinder 105, the translators 120 and the LEMs 200. However, many units can be placed in parallel, which could collectively be referred to as “the linear generator assembly.” Some embodiments of the invention are modular such that they can be arranged to operate in parallel to enable the scale of the linear generator assembly to be increased as needed by the end user. Additionally, not all units need to be the same size or operate under the same conditions (e.g., frequency, stoichiometry, or breathing). When the units are operated in parallel, there exists the potential for integration between the linear generator assemblies, such as, but not limited to, gas exchange between the units and/or feedback between the units' LEMs 200.

The free-piston architecture allows for large and variable compression and expansion ratios while maintaining sufficiently large volume at TDC to minimize heat transfer and achieve adequate reaction. In addition, the pistons spend less time at and near TDC than they would if they were mechanically linked to a crankshaft. This helps to minimize heat transfer (and maximize efficiency) because less time is spent at the highest temperatures. Furthermore, since the free-piston architecture does not have mechanical linkages, the mechanical and frictional losses are minimal compared to conventional linear generator assemblies. Together, the large and variable compression and expansion ratios, the sufficiently large volume at TDC, the direct conversion of kinetic energy to electrical energy by the LEM, the inherently short time spent at and near TDC, and the ability to control reaction, enable the linear generator assembly 102 to operated based on reaction of a wide range of fuels and to achieve thermal efficiencies greater than 50%.

During operation, the losses within the linear generator assembly 102 include: reaction losses, heat transfer losses, electricity conversion losses, frictional losses, and blow-by losses. In some embodiments of the invention, reaction losses are minimized by performing reaction at high internal energy states, which is achieved by having the ability to reach high compression ratios while moderating reaction section temperatures. Heat transfer losses are minimized by having a sufficiently large volume at and near when reaction occurs such that the thermal boundary layer is a small fraction of the volume. Heat transfer losses are also minimized by spending less time at high temperature using a free-piston profile rather than a slider-crank profile. Frictional losses are minimized because there are no mechanical linkages. Blow-by losses are minimized by having well-designed piston seals and using driver gas that contains unburned fuel as part of the intake for the next reaction cycle. In some embodiments, the driver sections of this disclosure is arranged outboard of a magnet section of a translator. For example, FIG. 1 depicts air springs outboard of magnet portions of translators. A driver section can be arranged in a manner similar to either or both of the air springs of FIG. 1 and can be provided in addition to the air springs of FIG. 1.

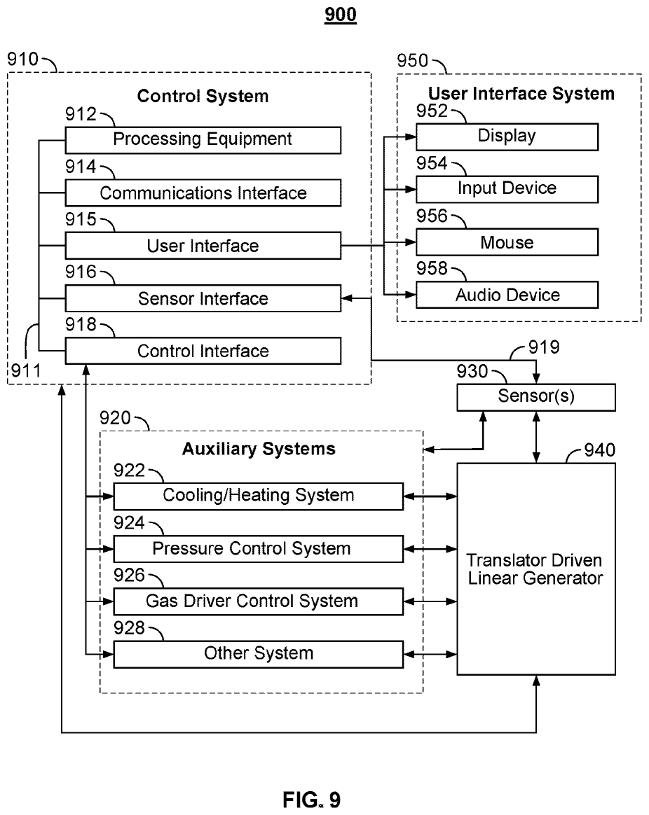

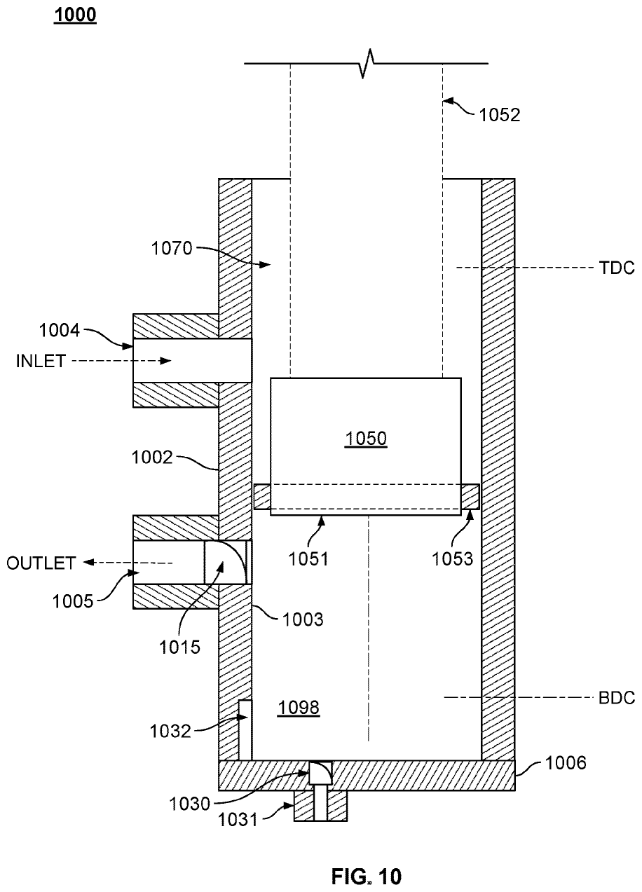

FIG. 9 is a block diagram of linear generator system 900 system, in accordance with some embodiments of the present disclosure. Linear generator system 900 can incorporate any or all components described in reference to or shown in FIGS. 1, 2, and 6-8. Linear generator system 900 can also be incorporated, in whole or in part, into the systems shown and described in reference to FIGS. 10-13. For example, control system 910 can be considered control computer 104 of FIG. 1.

Control system 910 may communicate with one or more sensors 930 coupled to translator driven linear generator 940. Control system 910 may be configured to communicate with auxiliary systems 920, which may be used to adjust operating aspects or properties of translator driven linear generator 940. In some embodiments, more than one piston engine may be controlled by control system 910. For example, control system 910 may be configured to communicate with auxiliary systems and sensors corresponding to any number of piston engines. In some embodiments, control system 910 may be configured to interact with a user via user interface system 950.

Control system 910 may include processing equipment 912, communications interface 914, sensor interface 916, control interface 918, any other suitable components or modules, or any combination thereof. Control system 910 may be implemented at least partially in one or more integrated circuits, ASIC, FPGA, microcontroller, DSP, computers, terminals, control stations, handheld devices, modules, any other suitable devices, or any combination thereof. In some embodiments, the components of control system 910 may be communicatively coupled via individual communications links or a communications bus 911. Processing equipment 912 may include any suitable processing circuitry, such as one or more processors (e.g., a central processing unit), cache, random access memory (RAM), read only memory (ROM), any other suitable hardware components or any combination thereof that may be configured (e.g., using software, or hard-wired) to process information regarding translator driven linear generator 940, as received by sensor interface 916 from sensor(s) 930. Sensor interface 916 may include a power supply for supplying power to sensor(s) 930, a signal conditioner, a signal pre-processor, any other suitable components, or any combination thereof. For example, sensor interface 916 may include a filter, an amplifier, a sampler, and an analog to digital converter for conditioning and pre-processing signals from sensor(s) 930. Sensor interface 916 may communicate with sensor(s) 930 via communicative coupling 919, which may be a wired connection (e.g., using IEEE 802.3 ethernet, or universal serial bus interface), wireless coupling (e.g., using IEEE 802.11 “Wi-Fi”, or Bluetooth), optical coupling, inductive coupling, any other suitable coupling, or any combination thereof. Control system 910, and more particularly processing equipment 912, may be configured to provide control of translator driven linear generator 940 over relevant time scales. For example, a change in one or more temperatures may be controllable in response to one or more detected engine operating characteristics, and the control may be provided on a time scale relevant to operation of the piston engine (e.g., fast enough response to prevent overheating and/or component failure, to adequately provide apex control as described below, to allow for shutdown in the case of a diagnostic event, and/or for adequate load tracking).

Sensor(s) 930 may include any suitable type of sensor, which may be configured to sense any suitable property or aspect of translator driven linear generator 940. In some embodiments, sensor(s) may include one or more sensors configured to sense an aspect and/or property of a system of auxiliary systems 920. In some embodiments, sensor(s) 930 may include a temperature sensor (e.g., a thermocouple, resistance temperature detector, thermistor, or optical temperature sensor) configured to sense the temperature of a component of translator driven linear generator 940, a fluid introduced to or recovered from translator driven linear generator 940, or both. In some embodiments, sensor(s) 930 may include one or more pressure sensors (e.g., piezoelectric pressure transducers, strain-based pressure transducers, or gas ionization sensors) configured to sense a pressure within a section of translator driven linear generator 940 (e.g., a reaction section, or gas driver section), of a fluid introduced to or recovered from translator driven linear generator 940, or both. In some embodiments, sensor(s) 930 may include one or more force sensors (e.g., piezoelectric force transducers or strain-based force transducers) configured to sense a force within translator driven linear generator 940 such as a tensile, compressive or shear force (e.g., which may indicate a friction force or other relevant force information, pressure information, or acceleration information). In some embodiments, sensor(s) 930 may include one or more current and/or voltage sensors (e.g., an ammeter and/or voltmeter coupled to a LEM of translator driven linear generator 940) configured to sense a voltage, current, power output and/or input (e.g., current multiplied by voltage), any other suitable electrical property of translator driven linear generator 940 and/or auxiliary systems 920, or any combination thereof. In some embodiments, sensor(s) 930 may include one or more sensors configured to sense the position of the translator and/or any other components of the engine, the speed of the translator and/or any other components of the engine, the acceleration of the translator and/or any other components of the engine, the rate of flow, oxygen or NOx emission levels, other emission levels, any other suitable property of translator driven linear generator 940 and/or auxiliary systems 920, or any combination thereof.

Control interface 918 may include a wired connection, wireless coupling, optical coupling, inductive coupling, any other suitable coupling, or any combination thereof, for communicating with one or more of auxiliary systems 920. In some embodiments, control interface 918 may include a digital to analog converter to provide an analog control signal to any or all of auxiliary systems 920.

Auxiliary systems 920 may include a cooling system 922, a pressure control system 924, a gas driver control system 926, and/or any other suitable control system 928. Cooling/heating system 922 may include a pump, fluid reservoir, pressure regulator, bypass, radiator, fluid conduits, electric power circuitry (e.g., for electric heaters), any other suitable components, or any combination thereof to provide cooling, heating, or both to translator driven linear generator 940. Pressure control system 924 may include a pump, compressor, fluid reservoir, pressure regulator, fluid conduits, any other suitable components, or any combination thereof to supply (and optionally receive) a pressure controlled fluid to translator driven linear generator 940. Gas driver control system 926 may include a compressor, gas reservoir, pressure regulator, fluid conduits, any other suitable components, or any combination thereof to supply (and optionally receive) a driver gas to translator driven linear generator 940. In some embodiments, gas driver control system may include any suitable components to control any of the gas spring components. In some embodiments, other system 928 may include a valving system such as, for example, a cam-operated system, a solenoid system, or any other electromechanical device or electric machine to supply oxidizer and/or fuel to translator driven linear generator 940. Valving may also be used to regulate exhaust flow out of the engine, such as in an unported engine having, for example, a single translator arrangement or dual translator arrangement. Exhaust valves may be controlled with voice coils (e.g., linear motors) to allow uni-flow scavenging.

User interface 915 may include a wired connection, wireless coupling, optical coupling, inductive coupling, any other suitable coupling, or any combination thereof, for communicating with one or more of user interface systems 950. User interface systems 950 may include display 952, input device 954, mouse 956, audio device 958, a remote interface accessed via website, mobile application, or other internet service, any other suitable user interface devices, or any combination thereof. In some embodiments, a remote interface may be remote from the engine but in proximity to the site of the engine. In other embodiments, a remote interface may be remote from both the engine and the site of the engine. Display 952 may include a display screen such as, for example, a cathode ray tube screen, a liquid crystal display screen, a light emitting diode display screen, a plasma display screen, any other suitable display screen that may provide graphics, text, images or other visuals to a user, or any combination of screens thereof. In some embodiments, display 952 may include a touchscreen, which may provide tactile interaction with a user by, for example, offering one or more soft commands on a display screen. Display 952 may display any suitable information regarding translator driven linear generator 940 (e.g., a time series of a property of translator driven linear generator 940), control system 910, auxiliary systems 920, user interface system 950, any other suitable information, or any combination thereof. Input device 954 may include a QWERTY keyboard, a numeric keypad, any other suitable collection of hard command buttons, or any combination thereof. Mouse 956 may include any suitable pointing device that may control a cursor or icon on a graphical user interface displayed on a display screen. Mouse 956 may include a handheld device (e.g., capable of moving in two or three dimensions), a touchpad, any other suitable pointing device, or any combination thereof. Audio device 958 may include a microphone, a speaker, headphones, any other suitable device for providing and/or receiving audio signals, or any combination thereof. For example, audio device 958 may include a microphone, and processing equipment 912 may process audio commands received via user interface 915 caused by a user speaking into the microphone.

In some embodiments, control system 910 may be configured to receive one or more user inputs to provide control. For example, in some embodiments, control system 910 may override control settings based on sensor feedback, and base a control signal to auxiliary system 920 on one or more user inputs to user interface system 950. In a further example, a user may input a set-point value for one or more control variables (e.g., temperatures, pressures, flow rates, work inputs/outputs, or other variables) and control system 910 may execute a control algorithm based on the set-point value.

In some embodiments, operating characteristics (e.g., one or more desired property values of translator driven linear generator 940 or auxiliary systems 920) may be pre-defined by a manufacturer, user, or both. For example, particular operating characteristics may be stored in memory of processing equipment 912, and may be accessed to provide one or more control signals. In some embodiments, one or more of the operating characteristics may be changed by a user. Control system 910 may be used to maintain, adjust, or otherwise control those operating characteristics. For example, control system 910 may be used to alter operation based on environmental conditions such as temperature and pressure.

In some embodiments, control system 910 computes a position-force trajectory for the one or more translators in a free-piston engine based at least in part on a desired engine performance (e.g., a desired apex position) and a current position of one or more translators. Based on the calculated position-force trajectory, control system 910 effects the displacement of the one or more translators by applying particular forces to the one or more translators over a specified time or position intervals. The calculation of each position-force trajectory by control system 910 is computed without regard to a deviation from a previously determined trajectory (position-force, time-position, or any other suitable trajectory). Control system 910 may calculate a position-force trajectory when a particular trigger is activated (e.g., in response to a particular event), repeatedly over an engine stroke or cycle, after changes to the operating state of the engine, or any combination thereof. In some embodiments, control system 910 may also calculate a position-force trajectory without regard to the timing of a desired engine performance. In some instances, control system 910 may calculate a position-force trajectory based on the operating state of the engine. In some embodiments, control system 910 may estimate a current operating parameter of the engine based on a preceding force that was calculated as part of a previous position-force trajectory or based on a preceding force that was applied to the one or more translators. In certain instances, control system 910 may calculate a position-force trajectory using a closed-form solution, a numerically iterative solution, or a combination of both. In embodiments with multiple translators, control system 910 may, in addition to calculating a position-force trajectory for each respective translator, also calculate synchronization forces for the multiple translators and cause certain forces to be applied to the multiple translators based on the synchronization calculations to synchronize the movements of the multiple translators as desired. In some embodiments, the control system 910 may employ a hybrid control strategy that switches between a position-force trajectory control technique and another control technique (e.g., a control technique that relies on the calculation of deviation from a previously determined trajectory) depending on the operating state of the engine.

The following is a discussion of some illustrative embodiments implemented in accordance with the concepts described above. These embodiments generally relate to single- and dual-piston free-piston engines (e.g., internal reaction engines or otherwise) with driver sections. In these embodiments, control system 910 is used to cause displacement of respective translators based on a desired engine performance. It will be understood that implementations and concepts discussed with reference to these specific embodiments are generally applicable to other embodiments as well. This discussion is provided for purposes of illustration and is not intended to limit the applicability of the disclosed implementations and concepts to only these embodiments.

FIG. 10 shows a cross-sectional view gas spring system 1000, in accordance with some embodiments of the present disclosure. Gas spring system 1000 can be incorporated into, or incorporate, gas springs 116a and 116b of FIG. 1.

Gas spring system 1000 includes gas spring cylinder 1002 having bore 1003, piston 1050 (e.g., part of translator 1052), lower-pressure port 1004, higher-pressure port 1005, valve 1015, and cylinder head 1006. In some embodiments, gas spring 1098 is the volume formed between piston face 1051 and gas spring cylinder 1002 and cylinder head 1006. Seal 1053 is configured to seal the gas between piston 1050 and bore 1003, although in some embodiments, seal 1053 is not needed. In some embodiments, seal 1053 includes a sealing ring assembly (e.g., formed from graphite, plastics, metals or other suitable materials and configured to wear against bore 1003, oiled sealing rings, or any other suitable sealing rings). In some embodiments, seal 1053 is configured for oil-less operation (e.g., sealing without the use of oil or liquid for lubrication). Gas spring 1098 is configured to store and release energy during compression and expansion, respectively, as the gas pressure in gas spring 1098 changes.

In some embodiments, lower-pressure port 1004 is configured to allow gas to flow into bore 1003, when piston 1050 (e.g., and seal 1053) uncovers lower-pressure port 1004. In some embodiments, lower-pressure port 1004 is configured for near atmospheric breathing (e.g., 1 atm±0.5 atm), during which atmospheric air at atmospheric pressure is drawn into bore 1003 (e.g., wherein the pressure in bore 1003 is lower than the atmospheric pressure). For example, at the end of a stroke as a translator moves from BDC to TDC (e.g., a gas spring expansion), the gas pressure in gas spring 1098 may be sub-atmospheric at or near BDC due to losses. To illustrate, mass loss may occur from gas spring 1098 past seal 1053 referred to herein as “blow-by,” or through higher-pressure port 1005 via valve 1015 referred to herein as “higher-pressure breathing.” In some embodiments, gas from behind seal 1053 (i.e., away from piston face 1051) may interact with lower-pressure port 1004. For example, in some circumstances, gas behind seal 1053 may flow between lower-pressure port 1004 and the volume behind piston 1050 (i.e., driver back section 1070). In some embodiments, driver back section 1070 is open to near atmosphere. In some embodiments, driver back section 1070 may be open to near atmospheric pressure (e.g., 1 atm±0.5 atm). In some embodiments, driver back section 1070 may be sealed from near atmospheric pressure. For example, a gas seal may seal between translator 1052 and gas spring cylinder 1002. In a further example, driver back section 1070 may be sized to reduce or limit compression work of gas within driver back section 1070 during strokes of a cycle. In some embodiments, lower-pressure port 1004 is configured for boosted air breathing, during which boosted air at higher than atmospheric pressure is drawn into bore 1003. For example, a boost blower may be used to supply inlet air (e.g., makeup air) to lower-pressure port 1004, which provides the makeup air to gas spring 1098. In some embodiments, lower-pressure port 1004 is located in cylinder head 1006 or near cylinder head 1006 (e.g., but still arranged in cylinder 1002). Any suitable number of lower-pressure ports 1004, having any suitable size, location, or both, may be included in a gas spring system. In some embodiments, lower-pressure port 1004 is valved (e.g., where a reed valve is positioned to regular flow with respect to lower-pressure port 1004), or otherwise controllable with respect to being “opened” or “closed.” In some embodiments, lower-pressure port 1004 is configured to allow gas to exit gas spring 1098. For example, a gas spring system may include a first lower-pressure port for supplying makeup air to gas spring 1098, and a second lower-pressure port for delivering air from gas spring 1098. In an illustrative example, a lower-pressure port may be used to supply reaction intake air (e.g., at a suitable boost pressure by using a timed valve).

Higher-pressure port 1005 is configured to allow the gas of gas spring 1098 to exit bore 1003 when the gas pressure of gas spring 1098 is above a threshold. In some embodiments, valve 1015 is configured to prevent the flow of gas until the pressure of gas spring 1098 is above a threshold (e.g., as regulated or achieved by incorporation of a reed valve). The threshold may be, for example, the pressure downstream of valve 1015, a cracking pressure of valve 1015, or any other suitable threshold. In some embodiments, higher-pressure port 1005 is configured to provide higher-pressure gas to systems outside of bore 1003. For example, in some embodiments, higher-pressure port 1005 may be coupled to a gas bearing system and may supply bearing gas to the bearing system. Accordingly, in some embodiments, the gas spring system may also function as a gas compressor. Valve 1015 may include any suitable type of valve such as, for example, a check valve, a reed valve, or any other suitable passive (e.g., spring loaded) or active (e.g., actuated) valve. In some embodiments, the BDC position is nearer to head 1006 than higher-pressure port 1005. For example, in some embodiments, during a stroke to the BDC position, seal 1053 may move past higher-pressure port 1005, and accordingly gas spring 1098 may not significantly transmit pressure with higher-pressure port 1005. In some embodiments, gas from gas spring 1098 may flow through valve 1015 when the pressure in gas spring 1098 is above a threshold and seal 1053 is neither blocking higher-pressure port 1005 or nearer to head 1006 than higher-pressure port 1005. In an illustrative example, the peak pressure in gas spring 1098, achieved at or near BDC, may be twenty bar or more, while the gas exiting valve 1015 may be six bar or less. This example is merely illustrative, and any suitable position of higher-pressure port 1005 and BDC may be used, and any suitable pressures may be achieved (e.g., several bar to well over fifty bar) in gas spring 1098. Any suitable number of higher-pressure ports 1015, having any suitable size, location, or both, may be included in a gas spring system. Higher-pressure port 1005 may be arranged in cylinder 1002, cylinder head 1006, any other suitable component, or any combination thereof (e.g., multiple higher-pressure ports, or ports formed at interfaces of components).

In some embodiments, a gas spring system need not include a higher-pressure port. For example, a gas spring system may include a lower-pressure port to provide make-up air during a breathing process to counteract blow-by during compression and expansion of gas spring 1098 (e.g., to maintain near consistent cycle-to-cycle operation). In a further example, a lower-pressure port may include a valve (e.g., arranged in the gas spring cylinder or head), coupled to a gas source, supply, or reservoir, and configured to allow make-up gas to flow into the bore during a breathing process. A lower pressure port (e.g., a make-up-air port) may be arranged at any suitable location including, for example, in a cylinder head (e.g., configured to only open when the translator is near TDC) or cylinder wall.

In some embodiments, a gas spring system need not include a lower-pressure port. For example, in some embodiments, when piston 1050 is near the TDC position, air from behind piston 1050 (i.e., driver back section 1070 which is away from piston face 1051) may flow past seal 1053 into gas spring 1098.

In some embodiments, a gas spring system need not include a lower-pressure port or a higher-pressure port.

In some embodiments, gas spring system 1000 may include one or more features 1032 for removing energy from gas spring 1098, limiting peak pressure in gas spring 1098, limiting a compression ratio of gas spring 1098, limiting an expansion ratio of gas spring 1098, or a combination thereof. In some embodiments, gas spring system 1000 includes pressure-relief port 1031, which may optionally include, for example, pressure relief valve 1030. In some embodiments, pressure-relief valve 1030 is configured to open when the pressure in gas spring 1098 exceeds a threshold. For example, pressure-relief valve 1030 may include a spring-loaded valve that opens when pressure in gas spring 1098 is sufficient to counteract the spring force. Pressure relief port 1031 may be included to protect against over-pressure conditions in gas spring 1098 by releasing energy from gas spring 1098 (e.g., to reduce forces acting on translator 1052). Optional pressure relief port 1031 may be included in cylinder head 1006, gas spring cylinder 1002, or both. Any suitable number of pressure relief ports, having any suitable cracking pressure, may be included in a gas spring system.

In some embodiments, gas spring system 1000 includes pressure-relief relief feature 1032. For example, pressure relief feature 1032 may include one or more axial grooves or scallops included in the bore of cylinder 1002 configured to provide a leak path around seal 1053 (i.e., as blowby) if seal 1053 moves past pressure relief feature 1032 (e.g., to a more extreme BDC position). One or more of length, axial position, and depth of feature pressure relief 1032 may be configured to introduce and maintain the leak path for a predetermined position of piston 1050. In some embodiments, one or more pressure relief features 1032 may be included to provide pressure relief in gas spring 1098 without the need for mechanical or moving parts (e.g., such as pressure-relief valve 1030).

In some embodiments, seal 1053 allows backflow when the pressure in driver back section 1070 is greater than the pressure in gas spring 1098. For example, seal 1053 may seal against bore 1003 when the pressure in gas spring 1098 is greater than the pressure in driver back section 1070 (e.g., greater than, or greater than by a threshold). In a further example, when the pressure in gas spring 1098 is less than the pressure in driver back section 1070 (e.g., less than, or less than by a threshold), seal 1053 may allow gas from driver back section 1070 to flow into gas spring 1098 (i.e., backflow). To illustrate, in some such embodiments, where seal 1053 is configured to allow backflow, cylinder 1002 may need not include lower pressure port 1004. Make-up gas may enter gas spring 1098 from driver back section 1070 by flowing across seal 1053 when the pressure in driver back section 1070 is greater than (or greater than by a threshold) the pressure in gas spring 1098.

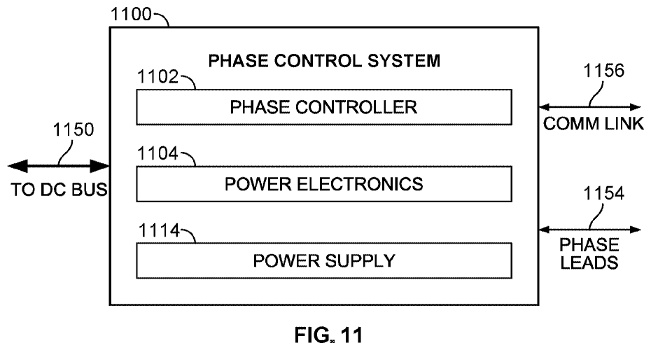

FIG. 11 shows a block diagram of phase control system 1100, in accordance with some embodiments of the present disclosure. Phase control system can be incorporated into any or all of the linear generators and systems thereof of this disclosure in order to provide precise control of the various operational conditions of this disclosure to ensure ideal conditions for compression reactions of air-fuel mixtures.

Phase control system 1100, as shown illustratively in FIG. 11, includes phase controller 1102, power electronics 1104, and power supply 1114. In some embodiments, each phase control system (e.g., similar to phase control system 1100) controls an application of current to a single phase of a multiphase stator. Further, each phase control system may include elements of the overall electrical system distributed to each phase control system. In an illustrative example, phase control system 1100 may be included along with other phase controllers (e.g., other similar controllers) to control one or more phases of a plurality of phases of a stator.

In some embodiments, phase controller 1102 is configured to control current in one or more phases of a stator. In some embodiments, a desired or commanded current to be applied to the corresponding phase is calculated locally by phase controller 1102. In some embodiments, a desired or commanded current to be applied to the one or more phases is communicated from a central controller, which determines currents to be applied on each of the phases (e.g., of the stator, and optionally other phases of other stators). For example, the desired or commanded current to be applied to the one or more phases may be determined to achieve a measured magnet or translator position, to achieve a total LEM force (e.g., summed from the electromagnetic force applied by each phase), to a achieve a translator velocity or acceleration, to achieve a desired translator position (e.g., an apex position), or any combination thereof.

In some embodiments, phase controller 1102 is configured to sense magnetic flux in the corresponding phase. For example, phase controller 1102 may sense the phase's magnetic flux and use the sensed flux as a control feedback. In some such embodiments, phase controller 1102 need not include a current sensor or be configured to receive input from a current sensor. Further, in some such embodiments, phase controller 1102 includes a current sensor with relatively reduced performance, requirements, cost, or a combination thereof.

In some embodiments, the current applied to or voltage applied across each phase is controlled locally (i.e., by an instance of phase control system 1100) to any suitable degree. In some embodiments, phase controller 1102 may execute a local control loop on phase current. For example, a current command may be communicated over a communication link from a central controller to phase controller 1102. Any suitable part of the control mechanism may also be distributed in accordance with the present disclosure. For example, a position measurement may be distributed to every phase and each phase controller 1102 may determine desired position and force to determine a current command, which may be applied by power electronics 1104.

In some embodiments, phase controller 1102 is configured to provide a control signal to power electronics 1104. Power electronics 1104 is configured to electrically couple to the phase leads of the phase, and provide the current to the phase. Accordingly, power electronics 3504 includes components configured for amperages and voltages relevant to the DC bus and phase leads. For example, power electronics 3504 may include any suitable components of power electronics system 206 of FIG. 2. Phase controller 1102 need not be configured to electrically control or interact with such large currents or voltages as required by the phase leads and power electronics 1104. In some embodiments, phase controller 1102 and power electronics 1104 may be combined or integrated into a single module configured to control and apply current to the phase. In some embodiments, power electronics 1104 may be shared among more than one phase. For example, power electronics 1104 may include multiple power circuits, be configured to receive multiple control signals, and be configured to apply current to more than one phase.

In some embodiments, each phase control system may estimate position of the translator relative to the stator, rather than a central algorithm estimating or measuring position. Accordingly, the central algorithm may be distributed among several phase control systems. In some embodiments, each position estimator for multiple phase control systems may be part of a distributed position estimator. The distributed position estimator may estimate position based on, for example, the sensing of phase voltage in each corresponding phase. In some such embodiments, a dedicated position sensor need not be included, thus saving the cost and reliability concerns of the position sensor.

Power supply 1114 is configured to power components of phase control system 1100, aside from applying current to the corresponding phase. For example, power supply 1114 may provide power for processing functions of phase controller 1102, diagnostics (e.g., for power electronics 1104), any other suitable process requiring power, or any suitable combination thereof. In some embodiments, each phase control system may include a power supply (e.g., similar to power supply 1114).

In some embodiments, suitable components of phase control system 1100 may be coupled to grid via coupling 1150. For example, power electronics 1104, may be coupled to coupling 1150. In some embodiments, coupling 1150 may include cables or buses transmitting AC power (e.g., three-phase 480 VAC). In some embodiments, coupling 1150 may include cables or buses transmitting DC power (e.g., a DC bus), which may be coupled to a grid via a grid-tie inverter separate from phase control system 1100, for example.

In some embodiments, suitable components of phase control system 1100 may be coupled to one or more phases of a LEM via phase leads 1154. For example, power electronics 1104 may be coupled to phase leads 1154. In some embodiments, phase leads 1154 may include two phase leads per phase corresponding to phase control system 1100 (e.g., six phase leads of three phases correspond to phase control system 1100, or a full bridge topology). In some embodiments, phase leads 1154 may include one phase lead per phase corresponding to phase control system 1100 (e.g., six phase leads of six wye-connected phases correspond to phase control system 800, or a half-bridge topology). In some embodiments, phase leads may be wired in a star configuration. For example, for a wye-type configuration, one phase lead from each phase may be coupled together to form a neutral (e.g., having net zero current input or output, so phase currents must sum to zero), while each phase control system applies a controlled phase voltage, and thus current, to the other lead of the corresponding phase. In some such embodiments, only some of the DC bus voltage (e.g., the difference between a bus and the neutral voltage) may be available to apply across each phase. In some embodiments, phase leads for each phase may be wired in an independent configuration. For example, a phase control system may include a full H-bridge per phase, and may be able to apply the full DC bus voltage across the phase in either direction (e.g., to cause a desired current to flow in either direction). This configuration provides a larger voltage range available to each phase as well as control independence from the other phases. For example, without a common neutral wye connection, the phase currents need not sum to zero.

In some embodiments, suitable components of phase control system 1100 may be coupled to communications (COMM) link 1156. For example, phase controller 1102, power electronics 1104, power supply 1114, or a combination thereof may be coupled to COMM link 1156. In some embodiments, COMM link 1156 may include a wired communications link such as, for example, an ethernet cable, a serial cable, any other suitable wired link, or any combination thereof. In some embodiments, COMM link 1156 may include a wireless communications link such as, for example, a WiFi transmitter/receiver, a Bluetooth transmitter/receiver, any other suitable wireless link, or any combination thereof. COMM link 1156 may include any suitable communication link enabling transmission of data, messages, signals, information, or a combination thereof. In some embodiments, phase control system 1100 is coupled to a central control system via communications link 1156. For example, in some embodiments, phase controller 1102 communicates with a central controller via COMM link 1156.

In some embodiments, phase control system 1100 may be configured to extract power from the corresponding phase of the LEM. For example, in the event of a detected system failure or loss of communication, phase controller 1102 may attempt to extract energy from the kinetic energy of a translator by commanding current in the opposite direction of a back emf in the corresponding phase.

In some embodiments, which include a long stator and short magnet section (e.g., the phases extend spatially beyond a magnet section), some phases are unused for at least some of the magnet travel. For example, when a portion of a magnet section is not under a phase (e.g., not axially overlapping with at least some of the phase), the phase will not interact electromagnetically with the magnet section in a significant way. Unused phases may be used as inductors and phase control system 1100 may be configured to store energy in capacitors or perform power conversion to help regulate the DC bus voltage, bus current, bus power, or a combination thereof. Accordingly, phase control system 1100, or phase controller 1102 thereof, may be used for other purposes besides exciting an electromagnetic force in the LEM.

In some embodiments, a LEM, or components thereof, may be tested, operated, characterized, measured, or otherwise interrogated. For example, a stator may be coupled by phase leads to power electronics, and current may be applied to phases to measure ohmic resistance, measure winding inductance, test for shorts among windings, test thermal response of the stator, test power electronics, test a control system, or a combination thereof. In a further example, a LEM may be coupled to power electronics by phase leads, coupled to a cooling system, and coupled to a bearing gas control system. The control system may cause the power electronics to apply current to the phase leads (e.g., to cause the translator to move axially and achieve a desired trajectory), cause the cooling system to provide a coolant (e.g., cooling air) to the stator, cause bearing gas to be provided to one or more bearing housings, and cause bearing gas to be provided to one or more anti-clocking bearing housings.

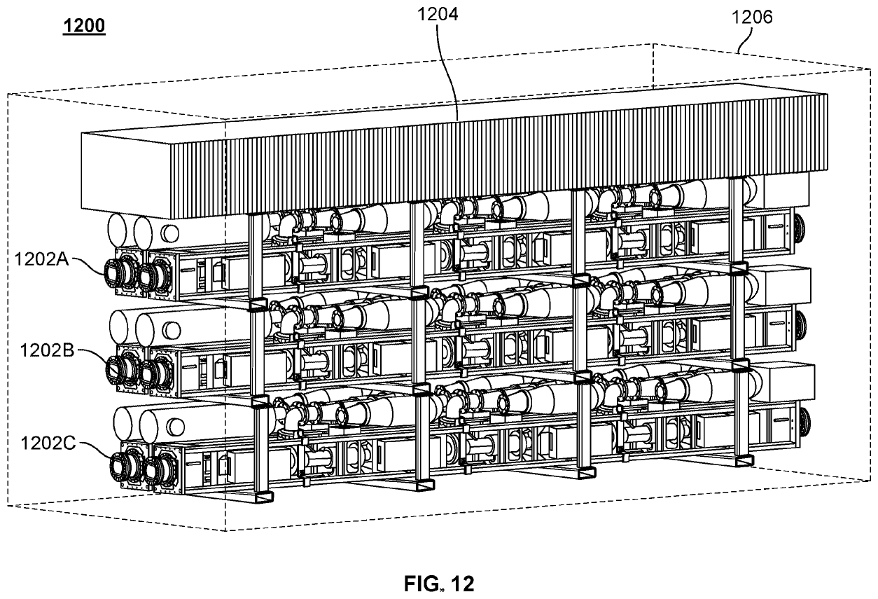

FIG. 12 shows LGEN assembly 1200, in accordance with some embodiments of the present disclosure. LGEN assembly 1200 represents an example architecture of a plurality of linear generator systems of this disclosure being configured to collectively generate an elevated power output for larger power generation applications. For example, each linear generator of LGEN assembly 1200 can incorporate any or all components of the linear generator systems of this disclosure in order to achieve the operational benefits of the various systems and methods of this disclosure.

LGEN assembly 1200 is comprised of dual cores 1202A-C. As shown in FIG. 12, LGEN assembly 1200 may be configured to generate 2 or more MW of power output based on the arrangement and interfacing of each of dual cores 1202A-C. Arranged along the top of stacked LGEN assembly 1200 is auxiliary box 1204. Auxiliary box 1204 may be configured to encompass, or house, one or more of intake components, exhaust components, or cooling subsystems as well as related plumbing. Auxiliary box 1204 may be configured for transport with stacked LGEN assembly 1200 to avoid risk of damage during transport of stacked LGEN assembly 1200. Stacked LGEN assembly 1200 incorporates three of generator core mounting assemblies for accommodating each of dual cores 1202A-C on different levels of stacked LGEN assembly 1200. A bottom side of the raised generator core mounting assemblies is affixed to a top side of the plurality of pillars of the generator core mounting assemblies that are arranged below the raised generator core mounting assemblies.

When servicing stacked LGEN assembly 1200 for maintenance purposes, operators must service replaceable elements such as sealing rings in each of the LEMs of the cores of stacked LGEN assembly 1200. For each of the depicted rows, each translator is to be articulated into a different position in order to access each sealing ring assembly of each LEM. One service strategy may include moving all translators of each LEM in one direction (e.g., all the way left or right) to replace half of the rings, then moving all translators in an opposite direction to replace the other half of the rings. In some embodiments, an overall height of LGEN assembly 1200 may exceed 10 feet, resulting in the incorporation of stairs or other catwalk related assemblies to access different levels of LGEN assembly 1200.

As shown in FIG. 12, stacked LGEN assembly 1200 can be housed within housing 1206 to create a power generation module. Housing 1206 defines an internal volume for accommodating a plurality of cores arranged in a matrix. An example of a matrix of cores is shown in FIG. 12 as a plurality of rows of cores and a plurality of columns of cores (e.g., three rows with two columns within each row corresponding to dual cores 1202A-C). Housing 1206 can be any suitable geometry to accommodate any of the assemblies of this disclosure. A power generation module as described herein can comprise any suitable combination of components for generating a desired cumulative power output.

A core, as that term is used herein, refers to a modular assembly of components in the implementation of the linear generator of the present disclosure. For example, a core can include a number of LEMs, a number of gas springs (e.g., a pair of gas springs located outboard of the LEMs on respective ends when the LEMs are aligned in sequence), and a number of reaction sections (e.g., arranged between adjacent LEMs). For example, a core can include an even or odd number of LEMs. While the present disclosure is generally described using embodiments in which a core includes four LEMs (e.g., where two of the LEMs are sized larger than the other two LEMs to provide larger respective power output than the smaller LEMs), it will be understood that any suitable number of LEMs arranged in any suitable manner to form a core may be used. A core is also referred to herein as a generator core and may include a single linear generator. In some embodiments, a linear generator core is provided in which certain constituent components are arranged linearly.

In some embodiments, one or more components, systems, or auxiliaries may be shared among cores. For example, exhaust tuned pipes may be shared among more than one core (e.g., each core need not have a dedicated exhaust system, or dedicated tuned pipes thereof). In some embodiments, two or more packages may be in communication with each other. For example, packages may be linked to each other communications-wise via a communications network (e.g., any suitable wired or wireless network). In a further example, packages may be linked by a shared fuel system, shared cooling system, shared intake system, shared exhaust system, shared control system, shared power electronics system, any other suitable shared system, or any combination thereof. In some embodiments, one or more cores may be synchronized to the other cores to achieve operating requirements, including efficiency, power, or noise. The implementation of LGEN assembly 1200 may be based on one or more of shipping constraints, installation constraints, or service constraints.

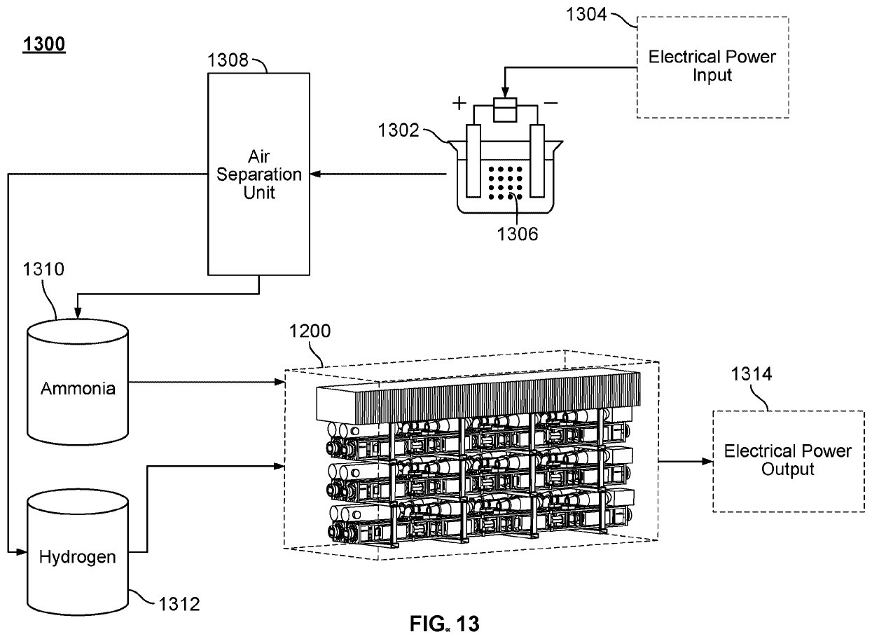

FIG. 13 is a block diagram of fueling architecture 1300, in accordance with some embodiments of the present disclosure. Fueling architecture 1300 can be configured to incorporate any or all assemblies or components described in reference to or shown in any of the preceding paragraphs. In some embodiments, LGEN assembly 1200 of FIG. 12 can be configured to execute any or all of the methods of this present disclosure and can be configured to operate using any suitable fuel of this disclosure.

Fueling architecture 1300 includes electrolysis unit 1302. Electrolysis unit 1302 comprises any suitable electrolyzer configured to cause a reaction of a liquid in reservoir 1306 to separate elements of the fuel based on the introduction of electrical current by electrolysis unit 1302 using electrical power input 1304 (e.g., where electrical power input 1304 passes between an anode and cathode to separate elements of the liquid in reservoir 1306). Electrical power input 1304 can be any suitable electrical power source, renewable or otherwise, for generating enough electrical current to complete electrolysis of liquid in reservoir 1306. For example, a renewable source (e.g., solar photovoltaic) may be used to electrolyze water to generate hydrogen, which may then be stored (e.g., for use as a fuel) or otherwise used as a feedstock to generate ammonia (e.g., using one or more of air separation or catalytic conversion). The electrolyzed liquid components are then provided to air separation unit 1308. Air separation unit 1308 can be configured to perform separation of the electrolysis products, or constituents, based on execution of any suitable process, including the use of processes performed by Haber-Bosch separation plants. The resulting products, or constituents, isolated by air separation unit 1308 can include ammonia, which is provided to ammonia tank 1310, and hydrogen, which is provided to hydrogen tank 1312. Ammonia tank 1310 and hydrogen tank 1312 are in fluid communication with one or more fuel reservoirs of LGEN assembly 1200. LGEN assembly 1200 can be configured to, for example, generate electrical power output 1314 based reaction (e.g., compression reaction), of one or more fuels, including either or both of ammonia or hydrogen. In some embodiments, LGEN assembly 1200 can be configured to use a combination of fuels (e.g., where a first fuel is used for one or more cycles and a second fuel is used for one or more other cycles, depending on availability of fuel from either or both of ammonia tank 1310 or hydrogen tank 1312). Fueling architecture 1300 can be sized, or developed, to support generation and storage of energy for distribution to a grid (e.g., as represented by electrical power output 1314) or other energy load such as a building or microgrid. The fuels stored in the tanks can be sized to provide a desirable amount of energy, for example for firming renewable energy sources or as backup power. In some embodiments, the stored energy can exceed 1000 hours of operation, thus serving as a long-term “battery.”

It will be understood that the present disclosure is not limited to the embodiments described herein and can be implemented in the context of any suitable system. In some suitable embodiments, the present disclosure is applicable to reciprocating generators and compressors. In some embodiments, the present disclosure is applicable to generators and compressors. In some embodiments, the present disclosure is applicable to reaction devices such as a reciprocating generator and a generator. A reaction device is inclusive of reaction related devices. A reaction, as used herein, is inclusive of both non-combustion reactions and combustion reactions. In some embodiments, the present disclosure is applicable to non-combustion and non-reaction devices such as reciprocating compressors and compressors. In some embodiments, the present disclosure is applicable to gas springs. In some embodiments, the present disclosure is applicable to oil-free reciprocating and generators and compressors. In some embodiments, the present disclosure is applicable to oil-free generators with internal or external reactions. In some embodiments, the present disclosure is applicable to oil-free generators that operate with compression ignition (e.g., homogeneous charge compression ignition, stratified charge compression ignition, or other compression ignition), spark ignition, or both. In some embodiments, the present disclosure is applicable to oil-free generators that operate with gaseous fuels, liquid fuels, or both. As used herein, the term “fuel” refers to matter that reacts (e.g., with an oxidizer). Suitable fuels for use with any or all of the systems, assemblies, or components of this disclosure include common gaseous alkanes or alkenes (e.g., methane, ethane, propane, ethylene, propene), alcohols (methanol, ethanol, propanol), hydrocarbon fuels (e.g., one or more of natural gas, biogas, gasoline, diesel, biodiesel, propane, or ethane), non-hydrocarbon fuels (e.g., one or more of hydrogen or ammonia), alcohol fuels (e.g., one or more of ethanol, methanol, or butanol) or any mixtures of any of the aforementioned fuels. The generators described herein are suitable for both stationary power generation and portable power generation (e.g., for one or more of power grid powering or vehicle propulsion). In some embodiments, the present disclosure is applicable to linear generators. In some embodiments, the present disclosure is applicable to generators that can be reaction generators with internal reaction or any type of heat generator with external heat addition (e.g., from a heat source or external reaction such as combustion).

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following numbered paragraphs.

What is claimed is:

1. A linear generator comprising:
a reaction section arranged between a pair of opposed translators;
at least one inlet port to provide air and ammonia to the reaction section;
an intake valve in fluid communication with an ammonia reservoir, wherein the intake valve is to provide ammonia from the reservoir to the at least one inlet port;
an air blower in fluid communication with the at least one inlet port;
an exhaust treatment assembly to catalyze exhaust products from the reaction section;
at least one exhaust port to expel exhaust from the reaction section, the at least one exhaust port in fluid communication with the exhaust treatment assembly;
a dosing valve arranged between the at least one exhaust port and the exhaust treatment assembly;
at least one sensor that monitors an output of the exhaust treatment assembly; and
control circuitry configured to:
determine a target power output of the linear generator;
cause the intake valve to be adjusted to affect a volume of flow of ammonia from the ammonia reservoir to the at least one inlet port based on the target power output;
cause the air blower to provide air that mixes with the flow of ammonia resulting in an air-fuel mixture propagating towards the at least one inlet port;
receive at least one signal from the at least one sensor; and
cause the exhaust dosing valve to be adjusted based on the at least one signal.

2. The linear generator of claim 1, wherein the exhaust treatment assembly comprises at least one catalyst.

3. The linear generator of claim 2, wherein the at least one catalyst comprises one or more of a selective catalytic reduction catalyst or an ammonia slip catalyst.

4. The linear generator of claim 1, wherein the target power output is determined based on a current operating state and a look-up table.

5. The linear generator of claim 1, wherein the target power output is determined based on one or more of a current cycle of the linear generator or a preceding cycle of the linear generator.

6. The linear generator of claim 1, wherein the linear generator is to cause a reaction to occur in the reaction section by compressing the air-fuel mixture using the pair of opposed translators.

7. The linear generator of claim 6, wherein:
the control circuitry is further configured to determine a compression ratio; and
the linear generator compresses the air-fuel mixture based on the compression ratio.

8. The linear generator of claim 1, wherein:
the intake valve comprises an opening;
the intake valve is configured to be adjusted by changing a size of the opening; and
the control circuitry is further configured to adjust the size of the opening based on the target power output.

9. The linear generator of claim 1, wherein the at least one signal from the at least one sensor comprises data indicative of exhaust content.

10. The linear generator of claim 1, wherein the control circuitry is further configured to cause the air blower to provide an amount of the air to generate a target air-fuel ratio in the air-fuel mixture based on the target power output.

11. The linear generator of claim 1, wherein the control circuitry is further configured to:
determine the linear generator is in a startup condition; and
in response to determining the linear generator is in the startup condition, determine the target power output comprises determining the target power output based on predictive operational parameters.

12. The linear generator of claim 11, wherein the control circuitry is further configured to:
a) determine the linear generator is no longer in the startup condition;
b) determine an updated target power output based on a previous cycle of the linear generator and based on the at least one signal from the at least one sensor;
c) adjust the intake valve based on the updated target power output; and
d) repeat b) and c) until the at least one signal of the at least one sensor indicate that a criterion for exhaust content has been met.

13. A method of operating a linear generator, the linear generator comprising:
at least one inlet port to provide air and ammonia to a reaction section arranged between a pair of translators;
an intake valve to provide ammonia from a reservoir to the at least one inlet port;
an air blower in fluid communication with the at least one inlet port;
at least one exhaust port to expel exhaust from the reaction section, the at least one exhaust port in fluid communication with an exhaust treatment assembly that catalyzes exhaust products from the reaction section;
a dosing valve arranged between the at least one exhaust port and the exhaust treatment assembly; and
at least one sensor that monitors an output of the exhaust treatment assembly;
the method comprising using control circuitry for:
determining a target power output of the linear generator;
causing the intake valve to be adjusted to affect a volume of flow of ammonia from the ammonia reservoir to the at least one inlet port based on the target power output;
causing the air blower to provide air that mixes with the flow of ammonia resulting in an air-fuel mixture propagating towards the at least one inlet port;
receiving at least one signal from the at least one sensor; and
causing the exhaust dosing valve to be adjusted based on the at least one signal.

14. The method of claim 13, wherein determining the target power output comprises:
receiving a linear generator operational load setpoint; and
computing the target power output based on the load setpoint.

15. The method of claim 13, wherein determining the target power output comprises:
identifying a current operating state of the linear generator; and
selecting the target power output from a look-up table based on the current operating state.

16. The method of claim 13, wherein:
the intake valve comprises an opening;
the intake valve is configured to be adjusted by changing a size of the opening; and
the method further comprises adjusting the size of the opening based on the target power output.

17. The method of claim 13, further comprising:
determining the linear generator is in a startup condition; and
in response to determining the linear generator is in the startup condition, determining the target power output comprises determining the target power output based on predictive operational parameters.

18. The method of claim 17, further comprising:
a) determining the linear generator is no longer in the startup condition;
b) determining an updated target power output based on a previous cycle of the linear generator and based on the at least one signal from the at least one sensor;
c) adjusting the intake valve based on the updated target power output; and
d) repeating b) and c) until the at least one signal of the at least one sensor indicate that a criterion for exhaust content has been met.

19. The method of claim 18, wherein the criterion is based on respective levels of one or more of ammonia or nitrogen oxide in the exhaust content.

20. The method of claim 13, further comprising causing a reaction to occur in the reaction section by compressing the air-fuel mixture using the pair of translators.

21. The method of claim 20, further comprising:
determining a compression ratio; and
compressing the air-fuel mixture based on the compression ratio.

22. The method of claim 13, further comprising causing the air blower to provide an amount of air to generate a target air-fuel ratio in the air-fuel mixture based on the target power output.

23. A system for generating and storing energy for distribution, the system comprising:
an electrolyzer to apply electric current to chemical compounds;
an air separation chamber to separate constituents of the chemical compounds subjected to the electric current;
at least one constituent storage tank for each separated constituent; and
a linear generator to generate an electrical power output based on reaction of one or more of the separated constituents, the linear generator comprising:
a reaction section arranged between a pair of opposed translators;
at least one inlet port to provide air and ammonia to the reaction section;
an intake valve in fluid communication with an ammonia reservoir, wherein the intake valve is to provide ammonia from the reservoir to the at least one inlet port;
an air blower in fluid communication with the at least one inlet port;
an exhaust treatment assembly to catalyze exhaust products from the reaction section;
at least one exhaust port to expel exhaust from the reaction section, the at least one exhaust port in fluid communication with the exhaust treatment assembly;
a dosing valve arranged between the at least one exhaust port and the exhaust treatment assembly;
at least one sensor that monitors an output of the exhaust treatment assembly; and
control circuitry configured to:
determine a target power output of the linear generator;
cause the intake valve to be adjusted to affect a volume of flow of ammonia from the ammonia reservoir to the at least one inlet port based on the target power output;
cause the air blower to provide air that mixes with the flow of ammonia resulting in an air-fuel mixture propagating towards the at least one inlet port;
receive at least one signal from the at least one sensor; and
cause the exhaust dosing valve to be adjusted based on the at least one signal.

24. A method of operating a linear generator, the method comprising:
determining, using control circuitry, a target power output of the linear generator;
determining, using the control circuitry, a compression ratio of the linear generator;
causing, using the control circuitry, ammonia from an ammonia reservoir to be provided to an inlet port of the linear generator based on the target power output;
causing, using the control circuitry, an air blower to provide air that mixes with the ammonia such that an air-fuel mixture propagates towards the inlet port;
causing, using the control circuitry, translators of the linear generator to compress the air-fuel mixture based on the compression ratio;
receiving, at the control circuitry, at least one signal from at least one sensor, wherein the at least one signal comprises data characterizing exhaust content generated based on compression of the air-fuel mixture; and
causing, using the control circuitry, the compression ratio and an ammonia dosing valve supplying ammonia to exhaust generated based on compression of the air-fuel mixture to be adjusted based on the data.
